(19) United States
(12) Patent Application Publication
(10) Pub. No.: US 2016/0011534 A1
(43) Pub. Date: Jan. 14, 2016

(54) BASE PARTICLE AND ELECTROSTATIC IMAGE DEVELOPING TONER

(71) Applicant: MITSUBISHI CHEMICAL CORPORATION, Tokyo (JP)

(72) Inventor: Shiho SANO, Niigata (JP)

(73) Assignee: MITSUBISHI CHEMICAL CORPORATION, Tokyo (JP)

(21) Appl. No.: 14/858,653

(22) Filed: Sep. 18, 2015

Related U.S. Application Data
(63) Continuation of application No. PCT/JP2014/057391, filed on Mar. 18, 2014.

(30) Foreign Application Priority Data
Mar. 19, 2013 (JP) 2013-057197
Mar. 29, 2013 (JP) 2013-071877
Feb. 4, 2014 (JP) 2014-019514

(51) Int. Cl. G03G 9/093; G03G 9/08

(52) U.S. Cl. CPC G03G 9/09364; G03G 9/0819; G03G 9/0827; G03G 9/09392; G03G 9/0825

(57) ABSTRACT

Provided are a toner base particle having a core-shell structure, which comprise: a core particle containing at least a binder resin and a colorant; and as a shell, a resin fine particle containing at least a release agent and attaching to the surface of the core particle, wherein a mass of the release agent contained in the specific area is from 50 to 100% of a mass of all release agents in said toner base particle, and a shape factor of said toner base particle is 150 or more, and an electrostatic image developing toner obtained by externally adding an external additive to the toner base particle.

### TECHNICAL FIELD

The present invention relates to an electrostatic image developing toner used for electrophotography, electrostatic photography, etc., and a toner base particle contained in the toner, i.e., the electrostatic image developing toner.

### BACKGROUND ART

In recent years, energy saving is considered as a major technical issue also for the electrophotographic apparatus. The specific challenge therefor includes drastically reducing the quantity of heat applied to a fixing device, and the electrostatic image developing toner is also subject to an increasing need for so-called low-temperature fixing capable of fixing with a lower energy.

For the purpose of low-temperature fixing, as found in Patent Document 1, an approach of facilitating the separation from a fixing roll by using a toner having added thereto a release agent is being taken. The toner having internally added to the entirety thereof a release agent is successful to a certain extent in the roll releasability but fails in satisfying all toner properties. One of the reasons therefor is that the distribution of the added release agent in the toner cannot be controlled.

The amount of the release agent added to the toner is preferably from 1 to 10% for satisfying the roll releasability, and the release agent is preferably present as near the toner surface as possible so as to increase the release effect. In this regard, the release agent-added toner can increase the release effect, because the amount of the release agent exposed on the surface is large.

However, on the other hand, when the amount of the release agent exposed on the toner surface is large, a blocking phenomenon may occur during use or the release agent may contaminate the photoreceptor surface to cause a problem in the development properties. In addition, the toner may exhibit poor storage stability due to the release agent exposed on the surface. It has been difficult for the release agent-added toner to satisfy all of low-temperature fixability, development properties and storage stability.

In an attempt to improve the defects of the release agent-added toner, in Patent Documents 2 and 3, production of a toner having a capsule structure has been proposed. The toner having a capsule structure is relatively free of a development-related problem such as blocking or filming, because the amount of the release agent (wax) exposed on the surface can be reduced.

However, such a toner with little surface release agent often fails in offering a sufficient release effect.

In order for the release agent to exert the release effect, a release layer by the release agent must be formed between the melted toner and the roll surface in a short time. However, in the case of a toner having a capsule structure, the release agent is included in a binder resin and subject to a delay until diffusing to the interface, and a release layer is not formed in time, resulting in a fixing failure.

Furthermore, the toner having a capsule structure with a hard shell requires a higher temperature to melt the resin, which makes it more difficult to ensure releasability from a roll in the process of fixing a color toner, etc. at a high speed.

In an attempt to improve the defects of the capsule toner, in Patent Document 4, a method of exposing part of the added release agent on the surface has been proposed.

However, in this method, like the above-described release agent-added toner, the release agent is exposed on the surface and therefore, an adverse effect on development properties, such as blocking or filming, and deterioration of the storage stability may be caused.

In addition, the release agent not exposed on the surface requires, similarly to the toner having a capsule structure, a high temperature for melting the surface resin so as to exert the effect as the release agent, and it has been very difficult to achieve a balance among low-temperature fixability, image properties and storage stability by this method.

A method of mixing a release agent particle only in the shell side of a capsule structure and attaching the release agent particle together with the shell particle has been attempted (Patent Document 5), but in this method, exposure of the release agent on the surface cannot be prevented, leaving a fear of contamination of a printer member.

As the method for enabling fixing at a lower temperature and suppressing the exposure of release agent on the surface, it has been proposed that the structure of a latex particle as a primary particle at the time of production of a toner is controlled by a polymerization method and a latex having a three-layer structure consisting of a low molecular weight latex, a release agent-containing high molecular weight latex and a medium molecular weight latex is formed into a toner base particle by salting-out/fusion (Patent Document 6).

However, this method is only the structure control of a primary particle and since the structure of a toner base particle itself cannot be controlled, it is impossible to satisfy both the low-temperature fixing and storage stability.

Demand for low-temperature fixability, development properties and storage stability is increasing, and the above-described known techniques fall short of achieving these characteristics, particularly, satisfying all of them, and more improvement is required.

### PRIOR ART LITERATURE

### Patent Document

Patent Document 1: JP-A-10-293413 (the term “JP-A” as used herein means an “unexamined published Japanese patent application”)
Patent Document 2: JP-A-2008-176346
Patent Document 3: JP-A-2008-107678
Patent Document 4: JP-A-10-207116
Patent Document 5: JP-A-2000-292978
Patent Document 6: Japanese Patent No. 4063064

### SUMMARY OF THE INVENTION

### Problems that the Invention is to Solve

The present invention has been made by taking into account the background art above, and an object of the present invention is to provide an electrostatic image developing toner that is excellent in the low-temperature fixability and development properties such as blocking resistance and filming resistance, excellent in the storage stability, and kept in balance, and a toner base particle for the toner.

Hereinafter, the “electrostatic image developing toner” obtained by externally adding an external additive to a toner base particle and used for development of an electrostatic image is sometimes simply referred to as “toner”. In addition, the “release agent” is also known as “wax”, but in the present invention, both “release agent” and “wax” are collectively referred to as “release agent”.

### Means for Solving the Problems

As a result of many intensive studies to attain the above-described object, the present inventors have found that with respect to a toner base particle having a core-shell structure, obtained by attaching, as a shell, a resin fine particle containing at least a release agent to the surface of a core particle containing at least a binder resin and a colorant, when for the outer side of a toner base particle having a shape factor larger than a certain value due to the presence, on the surface, of a convex part derived from the resin fine particle forming the shell, a toner base particle containing a release agent in a certain higher ratio than in the inner side of the toner base particle above is used, the electrostatic image developing toner obtained by externally adding an external additive thereto can solve the problem above. The present invention has been accomplished based on this finding.

In addition, conventionally, in a toner base particle where a release agent is incorporated into the shell, the glass transition temperature (Tg) (hereinafter, simply referred to as “Tg”) of the shell-forming resin fine particle (hereinafter, sometimes simply referred to as “shell agent”) is set to be as low as possible so as to form a round shape at a low temperature. However, it has been found that even if a shell agent having a high Tg is used, when, for example, the composition or physical properties of the core particle or shell agent or the temperature range at the production of a toner base particle are specified, the average circularity of the toner base particle can be sufficiently increased. The present invention has been accomplished based on this finding.

That is, the present invention provides a toner base particle having a core-shell structure, which comprise: a core particle containing at least a binder resin and a colorant; and as a shell, a resin fine particle containing at least a release agent and attaching to the surface of the core particle, wherein

when out of transmission electron microscope (hereinafter, this is simply referred to as “TEM”) images of a cross-section of said toner base particle, a cross-sectional image where a long diameter of the cross-section is 80% or more of a volume median diameter (Dv) of said toner base particle is image-processed and an approximate ellipse having an area corresponding to 84.6% of a cross-sectional area of said toner base particle is delineated inside of said cross-section, a mass of the release agent contained outside of an approximate oval sphere obtained by rotating said approximate ellipse around the major axis thereof is from 50 to 100% of a mass of all release agents in said toner base particle, and a shape factor of said toner base particle is 150 or more.

Hereinafter, this aspect is sometimes simply referred to as “embodiment 1”.

The present invention provides a toner base particle having a core-shell structure, which comprise: a core particle containing at least a binder resin and a colorant; and as a shell, a resin fine particle containing at least a release agent and attaching to the surface of the core particle, wherein

a mass of the release agent in said shell is from 50 to 100% of a mass of all release agent in said toner base particle and a shape factor of said toner base particle is 150 or more.

Hereinafter, this aspect is sometimes simply referred to as “embodiment 2”.

The present invention provides a method for producing the toner base particle as described above, which is a method for producing a toner base particle having a core-shell structure and a shape factor of 150 or more, which comprise: a core particle containing at least a binder resin and a colorant; and as a shell, a resin fine particle containing at least a release agent and attaching to the surface of the core particle, the method comprising incorporating said release agent into said resin fine particle in an amount of 20 to 50 mass % relative to the entirety of said resin fine particle.

The present invention provides a toner base particle produced by the method of producing a toner base particle as described above.

The present invention provides an electrostatic image developing toner obtained by externally adding an external additive to a toner base particle, wherein a toner base particle after dispersing said electrostatic image developing toner in water and removing the external additive by using an external additive removing method of applying an ultrasonic wave in the presence of a nonionic surfactant, is the toner base particle as described above.

The present invention provides an electrostatic image developing toner obtained by externally adding an external additive to the toner base particle as described above.

The present invention provides a toner cartridge comprising the electrostatic image developing toner as described above.

### Advantage of the Invention

According to the present invention, an electrostatic image developing toner excellent in the low-temperature fixability, development properties and storage stability can be provided by solving the above-described problems or tasks.

Among others, localization of a release agent in the vicinity of the toner base particle surface enables low-temperature fixing, the development properties and storage stability are excellent thanks to a small amount of the release agent exposed on the surface, and furthermore, balancing these performances can be achieved.

In addition, since a large amount of the release agent is present in the toner base particle surface, the toner base particle as a whole effectively exhibits the release effect with a small release agent content, making low-temperature fixing possible, and in turn, an effect of reducing the problem of dust generation during use of the toner is also obtained.

### BRIEF DESCRIPTION OF THE DRAWINGS

FIG. 1A and FIG. 1B show a conceptual view of the toner base particle of the present invention; FIG. 1A is a conceptual view of an aspect of the circularity and average circularity of the toner base particle of the present invention and FIG. 1B is a conceptual view of an aspect of the shape factor of the toner base particle of the present invention.

FIG. 2 is an example of the toner base particle of the present invention and is a scanning electron microscope (SEM) photograph of Toner Base Particle No. (2) of Examples.

FIG. 3 is an example of the toner base particle not falling under the toner base particle of the present invention and is a scanning electron microscope (SEM) photograph of Toner Base Particle No. (8) of Examples.

FIG. 4 is a schematic view of an example illustrating one toner base particle and an approximate ellipse thereof for describing the definition of “approximate oval sphere” in embodiment 1 of the present invention.

FIG. 5 is a transmission electron microscope (TEM) photograph of the toner base particle of Example 1.

FIG. 6 is a transmission electron microscope (TEM) photograph of the toner base particle of Comparative Example 1.

### MODE FOR CARRYING OUT THE INVENTION

The present invention is described below, but the present invention is not limited to the following specific embodiments, and arbitrary modifications can be made therein within the scope of the technical idea.

The method for producing the electrostatic image developing toner (hereinafter, sometimes simply referred to as “toner”) of the present invention is not particularly limited, and it may be sufficient if the configuration described below is employed in the production method of a wet-process toner or a pulverization toner. In the present invention, a toner before external addition is referred to as “toner base particle”. That is, a toner is obtained by externally adding an external additive to a toner base particle.

Accordingly, the method for producing not only the toner of the present invention but also the toner base particle of the present invention is not particularly limited, and the configuration or production method described below may be employed by using a wet process or a pulverization process.

In the description of the present invention, unless otherwise indicated, mere expression “parts” indicates “parts by mass”, and mere expression “%” indicates “mass %”. Here, in the description of the present invention, “mass %” and “parts by mass” have the same meanings as “wt %” and “parts by weight”, respectively.

In the present invention, as descried above, the invention concerning the toner base particle includes embodiment 1 and embodiment 2.

Both the toner base particle of embodiment 1 and the toner base particle of embodiment 2 are in common in that “the toner base particle is a toner base particle having a core-shell structure, obtained by attaching, as a shell, a resin fine particle containing at least a release agent to the surface of a core particle containing at least a binder resin and a colorant, wherein the shape factor of the toner base particle is 150 or more”.

Both the toner base particle of embodiment 1 and the toner base particle of embodiment 2 can be produced by the same method, the problems to be solved by the invention and the advantage of the invention are the same, and the essential points of the technical idea of the invention are also in common.

Hereinafter, the shell-forming resin fine particle is sometimes simply referred to as “resin fine particle”.

### Prescriptions Common to Embodiment 1 and Embodiment 2

### <<Content Ratio of Release Agent Depending on Position of Toner Base Particle>>

The core particle in the toner base particle of the present invention must contain at least a binder resin and a colorant and may also contain “other components that can be contained in an ordinary toner base particle”, such as release agent.

However, in the case of incorporating a release agent into the core particle, it is necessary, in embodiment 1, to limit the mass of the release agent contained outside of the later-described approximate oval sphere to account for 50 to 100% of the mass of all release agents in the toner base material (particularly, the lower limit needs to be limited), and, in embodiment 2, to limit the mass of the release agent in the shell to account for 50 to 100% of the mass of all release agents in the toner base material (particularly, the lower limit needs to be limited).

The shell in the toner base particle of the present invention must contain at least a release agent and a resin fine particle, and the shell must be formed by subjecting a resin fine particle containing at least a release agent to a treatment such as attaching and heating, but the resin fine particle for forming the shell may also contain “other components that can be contained in an ordinary toner base particle”.

The resin fine particle contains a release agent, but in embodiment 1, the mass of the release agent contained outside of the later-described approximate oval sphere needs to be specified to account for 50 to 100% of the mass of all release agents in the toner base material (particularly, the lower limit needs to be limited), and in embodiment 2, the mass of the release agent in the shell needs to be specified to account for 50 to 100% of the mass of all release agents in the toner base material (particularly, the lower limit needs to be limited).

### <<Shape Factor of Toner Base Particle>>

The toner base particle of the present invention must have a shape factor of 150 or more. The shape factor is preferably 170 or more, more preferably 190 or more, still more preferably 210 or more, which is the calculated value assuming that the shell covers 80% of the core particle surface, and yet still more preferably 220 or more.

The upper limit is not particularly limited but is preferably 350 or less, more preferably 300 or less.

When the shape factor satisfies the lower limit above, the toner surface has many irregularities, i.e., the “shell-forming resin fine particle” containing a release agent undergoes intense surface localization, and therefore, the low-temperature fixing and the blocking resistance are well balanced. On the other hand, when the shape factor satisfies the upper limit above, uniform attachment of an external additive is achieved and in turn, an image defect can hardly occur.

### <<<Definition of Shape Factor>>>

The “shape factor” is measured by the following method and is defined as the value measured by this measurement method.

The SEM observation of a toner base particle was performed using FE-SEM, S-4500, manufactured by Hitachi Ltd. An image at a magnification of 5,000 is incorporated for the image analysis and with respect to randomly selected 50 toner base particles, SF2 of one toner base particle is calculated according to the following formula (1):

SF2=100×[projected circumferential length of toner base particle]²/(4π×[projected area of toner base particle]) (1)

The arithmetic average value of SF2 of 50 toner base particles measured is determined and defined as the “shape factor”.

### <Shape of Toner Base Particle of the Present Invention>

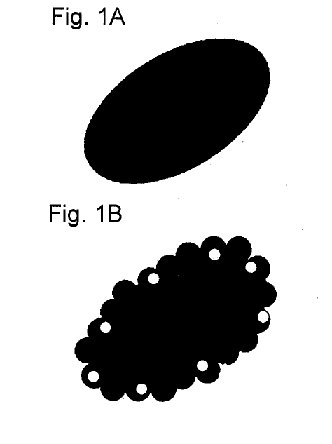

FIG. 1A shows a conceptual view of an aspect of the later-described “circularity and average circularity of the toner base particle as measured by a flow-type particle image analyzer” of the present invention. The average circularity of the toner base particle of the present invention is preferably 0.955 or more for obtaining a sharp printed image.

According to the later-described production method of a toner base particle of the present invention, a toner base particle having a large average circularity can be obtained.

On the other hand, FIG. 1B shows a conceptual view of an aspect of the shape factor of the toner base particle of the present invention. As described above, the shape factor of the toner base particle of the present invention must be 150 or more.

FIG. 1B is also a conceptual view showing the location of the release agent, and the release agent is indicated by a white circle.

For example, FIG. 1B is a case where the mass of the release agent contained outside of an approximate oval sphere is 100% of the mass of all release agents in the toner base particle (embodiment 1) and also a case where the mass of the release agent in the shell is 100% of the mass of all release agents in the total base particle (embodiment 2).

According to the later-described production method of a toner base particle of the present invention, a toner base particle having a large shape factor can be obtained. In addition, a toner base particle where the location of the release agent is as in embodiment 1 and embodiment 2 can be obtained.

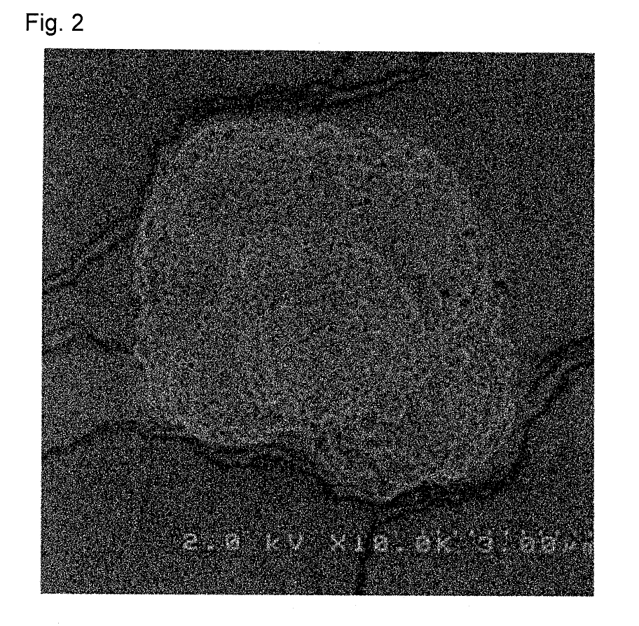

FIG. 2 is an example of the toner base particle of the present invention and is a scanning electron microscope (SEM) photograph of Toner Base Particle No. (2) of Examples described later.

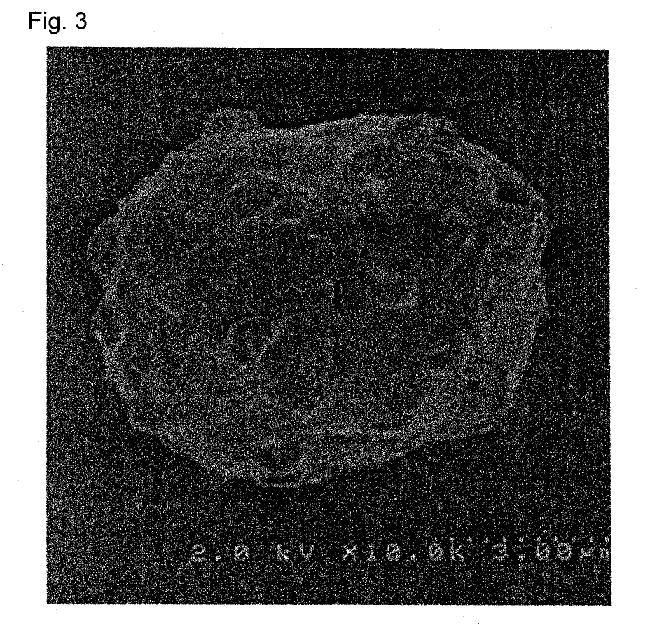

FIG. 3 is an example of the toner base particle not falling under the toner base particle of the present invention due to a too small shape factor and is a scanning electron microscope (SEM) photograph of Toner Base Particle No. (8) of Examples described later.

The toner base particle of the present invention has a large shape factor, and irregularities derived from a resin fine particle are present on the surface. On the other hand, the toner base particle of the present invention has a sufficiently large average circularity and is excellent in developability, etc.

In the toner base particle of the present invention, the shell-forming resin fine particle (shell agent) preferably sticks to the core particle surface without melting. It is preferred that only the core particle portion preferably melts and moves to form a round shape by the heating during the production of a toner base particle. In this case, the shell is not mixed with the core particle but remains on the surface.

When surface observation by SEM is performed, a bumpy surface is observed.

Such a preferable toner base particle is produced, as described later, by setting Tg of the shell agent to be higher than the ripening temperature, in other words, by setting the ripening temperature to be lower than Tg of the shell agent, whereby the toner base particle can be suitably produced.

The production process of the base particle of the present invention may include a temperature step not lower than the melting point of the release agent after adding the release agent-containing resin fine particle, but when the toner base particle is produced by setting the ripening temperature to be lower than the melting point of the release agent, the toner base particle can be more suitably produced. At the time of production of the toner, the production process after the addition of the release agent (wax) is performed at a temperature lower than the melting point of wax through the entire production process of the toner, whereby the toner can be more suitably produced.

In many cases, the melting point of the release agent is usually lower than Tg of the shell agent and in this case, by setting the ripening temperature to be lower than Tg of the shell agent, the toner base particle of embodiment 1 or embodiment 2 can be suitably produced. Furthermore, by setting the ripening temperature to be lower than the melting point of the release agent, the toner base particle of embodiment 1 or embodiment 2 can be more suitably produced.

There is also a method where the release agent particle is mixed only in the shell side of a core-shell structure and attaching the wax particle together with the shell particle (Patent Document 5 recited above). However, in this method, since, for example, a heating treatment is performed at a temperature not lower than the melting point of the release agent, it is expected that the release agent more hydrophobic than the resin slips inside of the toner base particle and the release agent does not stay near the surface. In addition, since a large amount of the release agent particle is added to the core particle whose fusion has proceeded, an agglomerate of only release agent particles failing to attach to the core particle is produced, and the actual printing performance is deteriorated due to the release agent agglomerate.

In the TEM image of a cross-section of the electrostatic image developing toner of the present invention (i.e., a cross-section of the toner base particle of the present invention), the shape of the release agent is preferably non-circular.

By setting the ripening temperature to a temperature lower than Tg of the shell agent, particularly, by setting the ripening temperature to a temperature lower than the melting point of the release agent, the release agent is hardly melted or not melted and is likely to form a non-circular shape by keeping the crystallinity.

Therefore, the release effect can be exerted in a shorter time during fixing. In addition, since the release agent is not compatibilized with the binder resin, the storage stability of the toner is also unimpaired.

A toner where in the TEM image of a cross-section of the electrostatic image developing toner, the ratio of the release agent in the circumferential length of the toner cross-section is 1.0% or less of the circumferential length of the toner cross-section, is preferred. That is, a toner base particle where in the TEM image of a cross-section of the toner base particle, the ratio of the length formed by the release agent surface in the entire circumferential length of the cross-section of the toner base particle is 1.0% or less of the entire circumferential length of the cross-section of the toner base particle, is preferred. This means that almost no release agent is exposed on the surface of the toner and toner base particle, and a toner using such a toner base particle is not subject to deterioration of the storage stability.

The kinds of the release agent, binder resin, colorant and other components, the form of the core-shell structure, and the production method, etc. of the core-shell structure are described later.

### Embodiment 1

In the toner base particle of embodiment 1, when an approximate ellipse having an area corresponding to 84.6% of the cross-sectional area of the toner base particle is delineated inside of a TEM image of a cross-section of the toner base particle, the mass of the release agent contained outside of an approximate oval sphere obtained by rotating the approximate ellipse around the major axis must be from 50 to 100% of the mass of all release agents in the toner base particle.

### <<Definitions of Approximate Ellipse and Approximate Oval Sphere>>

The definition of “approximate oval sphere” is as follows.

After a toner base particle is embedded and fixed in an epoxy resin in a conventional manner, an ultrathin section is prepared using a cryoultramicrotome.

The obtained ultrathin section is stained with ruthenium tetroxide and observed using TEM. An image of the toner base particle is incorporated for the image analysis and out of TEM images of the cross-section of randomly selected toner base particles, the cross-section is measured on 50 cross-sectional images of the toner base particle, where the long diameter of the cross-section is 80% or more of the volume median diameter (Dv) of the toner base particle.

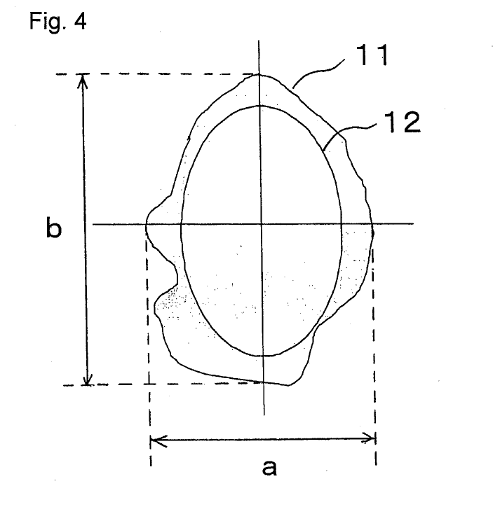

FIG. 4 shows a schematic view of one toner base particle for the definition of an approximate ellipse working out to a base of an approximate oval sphere.

The reason why out of TEM images of the cross-section of the toner base particle, only a cross-sectional image where the long diameter of the cross-section is 80% or more of the volume median diameter (Dv) of the toner base particle is image-processed is to remove a cross-sectional image of a toner base particle accidentally cut at a site distant from the vicinity of center of the toner base particle, because in the cross-sectional image of a toner base particle cut at such a site, the long diameter is small compared with the volume median diameter (Dv) of the toner base particle.

The maximum diameter length in a TEM image of a cross-section of a toner base particle is taken as “long diameter”, the midpoint of the long diameter is taken as the center of an ellipse, the length in the direction perpendicular to the edge of the cross-section of the toner base particle when drawing a perpendicular line passing through the midpoint is taken as the short diameter, and an ellipse A having the long diameter and the short diameter is envisaged.

The ellipse A is reduced in size at the same rate in vertical and horizontal directions around the center of the ellipse A, and an ellipse after the area of the ellipse is reduced to 84.6% of the area of the ellipse A is defined as “approximate ellipse”. An oval sphere obtained by rotating the approximate ellipse around the major axis is defined as “approximate oval sphere”.

### Content Ratio of Release Agent Depending on Position of Toner Base Particle of Embodiment 1

In embodiment 1 of the present invention, the mass of the release agent contained outside of the approximate oval sphere is from 50 to 100%, preferably from 65 to 100%, more preferably from 80 to 100%, still more preferably from 90 to 100%, of the mass of all release agents in the toner base material.

Assuming that the release agent is equally present in whatever direction the toner base particle is cut, the mass of the release agent contained outside of the three-dimensional approximate oval sphere can be determined by computation through two-dimensional TEM observation.

However, out of TEM images of the cross-section of the toner base particle, only a cross-sectional image where the long diameter of the cross-section is 80% or more of the volume median diameter (Dv) of the toner base particle is image-processed. Therefore, the cross-sectional image of the toner base particle accidentally cut at a site distant from the vicinity of center of the toner base particle (the long diameter becomes less than 80% of the volume medium diameter (Dv) of the toner base particle) is excluded from the computation above, because neither an approximate ellipse nor an approximate oval sphere is defined.

In embodiment 1, the mass of the release agent outside of an approximate oval sphere is specified, but the outside of the approximate oval sphere can be regarded as a shell formed by the attachment of a resin fine particle. However, in embodiment 1, as long as the portion is outside of the approximate oval sphere, even if it is derived from the core particle, the portion is the portion for specifying the release agent content, i.e., the “outside of the approximate oval sphere”.

When the ratio of the mass of the “release agent contained outside of the approximate oval sphere” to the mass of all release agent in the toner base particle is not less than the lower limit above, a toner base particle for an electrostatic image developing toner excellent in the low-temperature fixability, development properties, etc. can be provided.

Even if the ratio of the release agent is not less than the lower limit above, when Tg of the resin fine particle constituting the shell is set to be sufficiently high, “depopulation of shell”, i.e., a phenomenon that the shell becomes thin or uneven, is not seen, and not only the development properties, storage stability, etc. are kept from changing for the worse but also these performances can be excellently maintained.

Conversely, even if the mass of the “release agent contained inside of the approximate oval sphere” is small as specified by the lower limit above, when Tg of the core particle is set to be sufficiently low, formation of the toner base particle in round shape is not inhibited, and when the temperature during the production of a toner base particle having a core-shell structure is adjusted, the average circularity of the toner base particle can be sufficiently increased. Incidentally, the shape factor of the toner base particle may not decrease and need not be decreased.

In addition, even when the content of the release agent in the core particle or the content of the release agent inside of the approximate oval sphere is small or the release agent is not contained in these portions, a toner base particle for an electrostatic image developing toner excellent in the low-temperature fixability, development properties, etc. can be provided. For obtaining the effects of the present invention, it is particularly preferable not to contain the release agent inside of the approximate oval sphere.

Furthermore, a toner containing at least a binder resin, a colorant and a wax, which is an electrostatic image developing toner where assuming that the volume median diameter Dv50 of the toner is R μm, wax is present only in the layer substantially at R/4 μm or less below the toner surface, is preferred. In other words, in embodiment 1, a toner base particle where assuming that the volume median diameter Dv50 of the toner base particle is R [μm] (the same as the volume median diameter Dv50 of the toner), the mass of the release agent contained in a more inward side than the “surface of the toner base particle (the same as the surface of the toner)” and at the same time, in a more outward side than the “plane R/4 [μm] inside the surface of the toner base particle” is 100% of the mass of all release agents in the toner base particle, is preferred.

In many cases, the plane R/4 [μm] inside the surface of the toner base particle is usually located on a more inward side than the surface of the approximate oval sphere. In this case, a toner base particle where the mass of the release agent contained in a more outward side than the plane R/4 [μm] inside the surface of the toner base particle is 100% of the mass of all release agents in the toner base particle, produces the effects of the present invention and is preferred, and a toner base particle where the mass of the release agent contained outside of the approximate oval sphere is 100% of the mass of all release agents in the toner base particle, is more preferred.

### Embodiment 2

In the toner base particle of embodiment 2, the mass of the release agent in the shell must be from 50 to 100% of the mass of all release agents in the toner base particle. The “shell” is a portion formed by attachment of a release agent-containing resin fine particle and is a portion derived from a resin fine particle.

In embodiment 2, the “mass of the release agent in the shell” relative to the “mass of all release agents in the toner base particle” can be determined by computation from the mass (ratio) of the release agent incorporated into the core particle at the time of production, the mass (ratio) of the release agent incorporated at the time of production into the resin fine particle that forms the shell, and the blending ratio of the core particle and the resin fine particle, in the production process of the toner base particle, and is defined as a value obtained in this way.

In embodiment 2, similarly to the preferable ratio of the mass of the release agent contained outside of the approximate oval sphere to the mass of all release agents in the toner base particle of embodiment 1, the ratio of the mass of the release agent in the shell to the mass of all release agents in the toner base particle is preferably from 65 to 100%, more preferably from 80 to 100%, still more preferably from 90 to 100%.

For obtaining the effects of the present invention, it is particularly preferable not to contain the release agent in the core particle. In addition, among others, a production method of forming a shell on the surface of a core particle not containing a release agent is preferred.

Also in embodiment 2, a toner base particle where assuming that the volume median diameter Dv50 of the toner base particle is R [μm], the mass of the release agent contained in a more inward side than the “surface of the toner base particle” and at the same time, in a more outward side than the “plane R/4 [μm] inside the surface of the toner base particle” is 100% of the mass of all release agents in the toner base particle, is preferred.

In many cases, the plane R/4 [μm] inside the surface of the toner base particle is usually located on a more inward side than the boundary plane of core and shell in a core-shell structure. In this case, a toner base particle where the mass of the release agent contained in a more outward side than the plane R/4 [μm] inside the surface of the toner base particle is 100% of the mass of all release agents in the toner base particle, produces the effects of the present invention and is preferred, and a toner base particle where the mass of the release agent in the shell is 100% of the mass of all release agents in the toner base particle, is more preferred.

### Components Common to Embodiment 1 and Embodiment 2

The constituent components of the toner base particle, which are common to embodiment 1 and embodiment 2, are described below.

### [Release Agent]

In the toner base particle of the present invention, that is, in the toner, a release agent is blended for imparting release properties. The release agent is not particularly limited, and those having release properties can be used.

Specifically, the release agent includes, for example, an olefin-based wax such as low-molecular-weight polyethylene, low-molecular-weight polypropylene and copolymerized polyethylene; a paraffin wax; an ester-based wax having a long-chain aliphatic group, such as behenyl behenate, montanic acid ester and stearyl stearate; a vegetable wax such as hydrogenated castor oil and carnauba wax; a ketone having a long-chain alkyl group, such as distearyl ketone; a silicone having an alkyl group; a higher fatty acid such as stearic acid; a long-chain aliphatic alcohol such as eicosanol; a carboxylic acid ester or partial ester of a polyhydric alcohol, which is obtained from a polyhydric alcohol such as glycerin and pentaerythritol and a long-chain fatty acid; a higher fatty acid amide such as oleamide and stearamide; and a low-molecular-weight polyester.

As the compound species of the release agent, a higher fatty acid ester-based wax is preferred. Specifically, the higher fatty acid ester-based wax is preferably, for example, an ester of a fatty acid having a carbon number of 15 to 30 and a mono- to pentahydric alcohol, such as behenyl behenate, stearyl stearate, stearic acid ester of pentaerythritol, and montanic acid glyceride. As the alcohol component constituting the ester, a monohydric alcohol having a carbon number of 10 to 30 is preferred, and a polyhydric alcohol having a carbon number of 3 to 10 is preferred.

As the compound species of the release agent, an olefin-based wax and a paraffin wax are also preferred. Among others, a low-molecular-weight olefin-based or paraffin wax having a molecular weight of 1,000 to 10,000 is preferred, and a paraffin wax having a molecular weight of 2,000 to 7,000 is more preferred.

Among these release agents, for improving the release property, i.e., for improving the fixability of the toner, the melting point of the release agent is preferably 75° C. or more, more preferably 80° C. or more, and is preferably 100° C. or less, more preferably 95° C. or less. A release agent having a melting point in the range above does not cause sticking, etc. and ensures excellent fixability of the toner at a low temperature.

The above-described release agents may be used individually or may be used as a mixture. The melting point of the release agent can be appropriately selected according to the fixing temperature for fixing the toner.

The mass of the release agent is, per 100 parts by mass of the entire toner base particle, preferably 1 part by mass or more, more preferably 2 parts by mass or more, still more preferably 5 parts by mass or more, and is preferably 20 parts by mass or less, more preferably 15 parts by mass or less, still more preferably 13 parts by mass or less, yet still more preferably 10 parts by mass or less.

Since the amount of an external additive is generally very small, the preferable mass, etc. of the release agent are the same as those described above even when the “per 100 parts by mass of the entire toner base particle” is replaced with “per 100 parts by mass of the entire toner”.

If the release agent content in the toner base particle is too small, the performance such as high-temperature offset property may be inadequate, and if the content is too large, the blocking resistance may not be sufficient or the release agent may seep from the toner and contaminate the apparatus.

In the present invention, the release agent exists in a larger amount in the vicinity of the toner base particle surface, which is advantageous in that the release effect can be exerted with a smaller blending amount than ever before and in turn, dust generation due to sublimation of the release agent can be suppressed.

The particle diameter of the release agent used is preferably from 150 nm to 2 μm from the standpoint of ensuring the dispersibility in the toner base particle and facilitating bleed-out at the time of fixing.

The production method of the toner base particle of the present invention includes a case involving a temperature step not lower than the melting point of the release agent and lacking a temperature step not lower than Tg of the resin fine particle forming the shell. Therefore, the release agent does not move even when melted because of being wrapped in a resin fine particle forming a hard shell and on this account, the shape of the release agent in the toner base particle is substantially the same as the shape of the release agent in the resin fine particle as a raw material of the shell.

Although not limited to this, the production process after the addition of the release agent is preferably performed at a temperature lower than the melting point of the release agent. The toner base particle is preferably grown (ripened) at a temperature lower than the melting point of the release agent, because the release agent is not melted but forms a non-circular shape by keeping the crystallinity and can uniformly stay in the toner base particle surface while maintaining a relatively small dispersion diameter without causing fusion of release agents to each other.

### [Configuration of Toner Base Particle]

The component constituting the toner base particle of the present invention includes, for example, a binder resin, a colorant (pigment), and if desired, a charge-controlling agent, in addition to the above-described release agent.

### [Binder Resin]

The binder resin contained in the toner base particle of the present invention, i.e., the binder resin contained in the toner, is not particularly limited, and a resin known to be usable for a toner (base particle) can be used. Specifically, the resin includes, for example, a styrene-based resin, a vinyl chloride-based resin, a rosin-modified maleic acid-based resin, a phenolic resin, an epoxy-based resin, a saturated or unsaturated polyester-based resin, a polyethylene-based resin, a polypropylene-based resin, an ionomer resin, a polyurethane-based resin, a silicone-based resin, a ketone-based resin, an ethylene-acrylate copolymer, a xylene-based resin, a polyvinyl butyral-based resin, a styrene-alkyl acrylate copolymer, a styrene-alkyl methacrylate copolymer, a styrene-acrylonitrile copolymer, a styrene-butadiene copolymer, and a styrene-maleic anhydride copolymer.

One of these resins may be used alone, or some of them may be used in combination.

### [Colorant]

As the colorant, a known colorant can be arbitrarily used. Specific examples of the colorant include carbon black, aniline blue, phthalocyanine blue, phthalocyanine green, Hansa Yellow, a Rhodamine-based dye or pigment, chrome yellow, quinacridone, benzidine yellow, Rose Bengal, a triarylmethane-based dye or pigment, and a monoazo-based, disazo-based or condensed azo-based dye or pigment, and these may be used individually or may be used as a mixture.

In the case of a full-color toner, it is preferable to use benzidine yellow or a monoazo-based or condensed azo-based dye or pigment for the yellow; quinacridone or a monoazo-based dye or pigment for the magenta; and phthalocyanine blue for the cyan.

The colorant is preferably used, in the case of an emulsion polymerization aggregation method, to account for 3 to 20 parts by mass per 100 parts by mass of the primary polymer particle.

### [Charge-Controlling Agent]

A charge-controlling agent may be used in the toner, and in the case of using a chare-controlling agent, arbitrary known charge-controlling agents may be used individually or in combination.

For example, the positively chargeable charge-controlling agent include, e.g., a quaternary ammonium salt and a basic/electron-donating metal material. The negatively chargeable charge-controlling agent include, e.g., metal chelates; a metal salt of an organic acid; a metal-containing dye; a nigrosine dye; an amide group-containing compound; a phenol compound, a naphthol compound, and a metal salt thereof; a urethane bond-containing compound; and an acidic or electron-attractive organic substance.

In the case of using the toner as a toner other than a black color toner in a color toner or a full-color toner, a charge-controlling agent being colorless or having a pale color and not impairing the color tone of the toner is preferably used. In this case, for example, the positively chargeable charge-controlling agent is preferably a quaternary ammonium salt compound, and as the negatively chargeable charge-controlling agent, a metal salt or metal complex of salicylic acid or alkylsalicylic acid with chromium, zinc, aluminum, etc.; a metal salt or metal complex of benzylic acid; an amide compound; a phenol compound; a naphthol compound; a phenolamide compound; and a hydroxynaphthalene compound such as 4,4′-methylenebis[2-[N-(4-chlorophenyl)amide]-3-hydroxynaphthalene] are preferred.

### [External Additive]

In the toner base particle, an external additive is added to the toner base particle surface for controlling the flowability and developability, whereby a toner is obtained.

The external additive includes, for example, a metal oxide or hydroxide, such as alumina, silica, titania, zinc oxide, zirconium oxide, cerium oxide, talc and hydrotalcite; a metal salt of titanic acid, such as calcium titanate, strontium titanate and barium titanate; a nitride such as titanium nitride and silicon nitride; a carbide such as titanium carbide and silicon carbide; and an organic particle of acrylic resin, melamine resin, etc. One of these may be used, or a plurality thereof may be used in combination.

### Shape/Physical Properties, etc. Common to Embodiment 1 and Embodiment 2

### Particle Size Distribution (Dv/Dn) and BET Specific Surface Area

In the toner base particle of the present invention, it is preferred that the particle size distribution (Dv/Dn) obtained by dividing the volume median diameter (Dv) of the toner base particle by the number median diameter (Dn) is from 1.05 to 1.17 and the BET specific surface area of the toner base particle is from 1.3 to 6 times the calculated value of the BET specific surface area of a true sphere having a diameter corresponding to the volume median diameter (Dv) of the toner base particle.

If the particle size distribution (Dv/Dn) is less than the lower limit, production of a toner becomes difficult. If the particle size distribution (Dv/Dn) exceeds the upper limit, a problem is likely to arise with the image properties of the toner, such as blurring or fogging.

The BET specific surface area of the toner base particle is preferably from 1.4 to 5.6 times, more preferably from 1.6 to 5.3 times, the calculated value of the BET specific surface area of a true sphere having a diameter corresponding to the volume median diameter (Dv) of the toner base particle.

If the factor is less than the lower limit, the surface localization of the wax is not sufficiently achieved and the fixing temperature width may be narrow. In addition, since the shell agent is not localized on the surface, the storage stability may be deteriorated.

On the other hand, if the factor exceeds the upper limit, an external additive can hardly adhere, leading to an adverse effect on the image properties, such as generation of fog, blur, etc.

### <<Limitation of Average Circularity and Fine Powder>>

In the toner base particle of the present invention, it is preferred that the average circularity of the toner base particle as measured by a flow-type particle image analyzer is 0.955 or more and the number of toner base particles of 0.8 to 3.0 μm as measured by a flow-type particle image analyzer is 5% or less of the number of all toner base particles.

The average circularity is preferably 0.955 or more, more preferably 0.960 or more. When the average circularity is not less than the lower limit above, the flowability of the toner is enhanced and the development properties are improved. In addition, uniform attachment of an external additive is achieved to produce an effect of improving the storage stability or toner consumption.

In the present invention, Tg of the resin fine particle forming the shell is preferably set to be high, and as described later, by setting the ripening temperature to be higher, in both embodiment 1 and embodiment 2, the toner base particle of the present invention is easily produced. However, even in such a case, for example, by setting Tg of the core particle to be lower by a certain level or more than Tg of the resin fine particle or setting Tg of the core particle to be lower than the ripening temperature, the average circularity can be increased, making it possible to achieve the above-described average circularity, and the effects of the present invention are obtained.

When the lower limit of the average circularity satisfies the value above, the flowability, developability, etc. are improved, and in the above-described embodiment relating to the location of the release agent of the toner base particle, the effect thereof becomes particularly prominent.

The number of toner base particles of 0.8 to 3.0 μm as measured by a flow-type particle image analyzer is preferably 4% or less, more preferably 3% or less, still more preferably 2% or less, yet still more preferably 1% or less, of the number of all toner base particles.

When the upper limit of the “number of toner base particles of 0.8 to 3.0 μm as measured by a flow-type particle image analyzer” satisfies the value above, the flowability, developability, cleaning properties, etc. are improved, and in the above-described embodiment relating to the location of the release agent of the toner base particle, the effect thereof becomes particularly prominent.

### <Production Method of Toner Base Particle>

The production method of the electrostatic image developing toner according to the present invention is described below.

### <Production Method of Toner>

The production method of the toner of the present invention, i.e., the production method of the toner base particle, may be a dry process having melting/kneading and pulverization/classification steps or a wet process of producing the toner base particle in a liquid medium, but a wet process is preferably applied.

The wet process includes a suspension polymerization method, an emulsion polymerization aggregation method, a dissolution suspension method, etc., and the toner base particle may be produced by any of these methods without particular limitation, but, among others, a toner base particle produced by an emulsion polymerization aggregation method is preferred.

### <<Suspension Polymerization Method>>

In the suspension polymerization method, a colorant, a polymerization initiator and, if desired, a polar resin, a charge-controlling agent, a crosslinking agent, etc. are added to a monomer of a binder resin and uniformly dissolved or dispersed to prepare a monomer composition. This monomer composition is dispersed in an aqueous medium containing a dispersion stabilizer, etc. The monomer composition is granulated preferably by adjusting the stirring speed/time so that the liquid droplet can have the desired toner particle size. Thereafter, polymerization is performed while applying stirring to such an extent that the particle state is maintained by the action of the dispersion stabilizer and the particle is prevented from settling. The particles are then collected through washing/filtration, whereby a toner base particle is obtained.

### <<Dissolution Suspension Method>>

In the dissolution suspension method, a binder resin is dissolved in an organic solvent, a solution phase obtained after adding and dispersing a colorant, etc. is dispersed by means of mechanical shear force in an aqueous phase containing a dispersant, etc. to form a droplet, and the organic solvent is removed from the droplet, whereby a toner base particle is obtained.

### <<Emulsion Polymerization Aggregation Method>>

In the emulsion polymerization aggregation method, a primary polymer particle of a binder resin monomer, which is obtained in an emulsion polymerization step, a colorant dispersion liquid, etc, are prepared, dispersed in an aqueous medium and then subjected to an aggregation step by heating, etc. and further to a ripening step.

The obtained particles are collected through washing/filtration, whereby a toner base particle is obtained. The toner base particle is then subjected to a step for drying and furthermore, an external additive is externally added to the resulting toner base particle, whereby a toner is obtained.

The emulsion polymerization aggregation method is described in more detail below.

In the emulsion polymerization step, a polymerizable monomer working out to a binder resin is usually polymerized in an aqueous medium in the presence of an emulsifying agent, and in this case, at the time of feeding the polymerizable monomer to the reaction system, respective monomers may be added separately, or a plurality of kinds of monomers may be previously mixed and then added at a time. The monomer may be added as it is or may be added as an emulsion liquid prepared by previously mixing the monomer with water, an emulsifying agent, etc.

The polymerizable monomer includes an acidic monomer and a basic monomer.

The acidic monomer includes, for example, a carboxyl group-containing polymerizable monomer such as acrylic acid, methacrylic acid, maleic acid, fumaric acid and cinnamic acid, a sulfonic acid group-containing polymerizable monomer, such as sulfonated styrene, and a sulfonamide group-containing polymerizable monomer such as vinylbenzene sulfonamide.

The basic monomer includes, for example, an amino group-containing aromatic vinyl compound such as aminostyrene, a polymerizable monomer containing a nitrogen-containing heterocyclic ring, such as vinylpyridine and vinylpyrrolidone, and an amino group-containing (meth)acrylic acid ester such as dimethylaminoethyl acrylate and diethylaminoethyl methacrylate.

One of these acidic monomers and basic monomers may be used alone, a plurality of kinds thereof may be mixed and used, or the monomer may be present as a salt accompanied by a counter ion. Among these, an acidic monomer is preferably used, and the acidic monomer is more preferably an acrylic acid and/or a methacrylic acid.

The total amount of the acidic monomer and the basic monomer per 100 parts by mass of all polymerizable monomers constituting a binder resin is preferably 0.05 parts by mass or more, more preferably 0.5 parts by mass or more, still more preferably 1.0 parts by mass or more, and is preferably 10 parts by mass or less, more preferably 5 parts by mass or less.

Other polymerizable monomers include, for example, styrenes such as styrene, methylstyrene, chlorostyrene, dichlorostyrene, p-tert-butylstyrene, p-n-butylstyrene and p-n-nonylstyrene; acrylic acid esters such as methyl acrylate, ethyl acrylate, propyl acrylate, n-butyl acrylate, isobutyl acrylate, hydroxyethyl acrylate and 2-ethylhexyl acrylate; methacrylic acid esters such as methyl methacrylate, ethyl methacrylate, propyl methacrylate, n-butyl methacrylate, isobutyl methacrylate, hydroxyethyl methacrylate and 2-ethylhexyl methacrylate; and amides such as acrylamide, N-propylacrylamide, N,N-dimethylacrylamide, N,N-dipropylacrylamide and N,N-dibutylacrylamide. One polymerizable monomer may be used alone, or a plurality of polymerizable monomers may be used in combination.

The electrostatic image developing toner of the present invention contains, as the binder resin, a styrene-based resin that is a polymer from a single monomer of styrenes or a polymer from a monomer of styrenes and another monomer.

Furthermore, in the case of using a crosslinked resin as the binder resin, a polyfunctional monomer having radical polymerizability is used together with the above-described polymerizable monomer, and the polyfunctional monomer includes, for example, divinylbenzene, hexanediol diacrylate, ethylene glycol dimethacrylate, diethylene glycol dimethacrylate, diethylene glycol diacrylate, triethylene glycol diacrylate, neopentyl glycol dimethacrylate, neopentyl glycol diacrylate, and diallyl phthalate.

It is also possible to use a polymerizable monomer having a reactive group as a pendant group, such as glycidyl methacrylate, methylolacrylamide and acrolein. Among others, a bifunctional polymerizable monomer having radical polymerizability is preferred, and divinylbenzene and hexanediol diacrylate are more preferred. One of these polyfunctional polymerizable monomers may be used alone, or a plurality of kinds thereof may be mixed and used.

In the case of polymerizing the binder resin by emulsion polymerization, a known surfactant may be used as an emulsifying agent. As the surfactant, one surfactant selected from a cationic surfactant, an anionic surfactant and a nonionic surfactant may be used, or two or more surfactants selected therefrom may be used in combination.

The cationic surfactant includes, for example, dodecylammonium chloride, dodecylammonium bromide, dodecyltrimethylammonium bromide, dodecylpyridinium chloride, dodecylpyridinium bromide, and hexadecyltrimethylammonium bromide.

The anionic surfactant includes, for example, a fatty acid soap such as sodium stearate and sodium dodecanoate, sodium dodecyl sulfate, sodium dodecylbenzenesulfonate, and sodium laurylsulfate.

The nonionic surfactant includes, for example, polyoxyethylene dodecyl ether, polyoxyethylene monohexadecyl ether, polyoxyethylene nonylphenyl ether, polyoxyethylene lauryl ether, polyoxyethylene sorbitan monooleate ether, and monodecanoyl sucrose.

The amount of the emulsifying agent used is preferably from 0.1 to 10 parts by mass per 100 parts by mass of the polymerizable monomer. In combination with the emulsifying agent, one member or two or more members of, for example, polyvinyl alcohols such as partially or completely saponified polyvinyl alcohol, and cellulose derivatives such as hydroxyethyl cellulose, may be used as a protective colloid.

The volume average diameter (Mv) of the primary polymer particle obtained by emulsion polymerization is preferably 0.02 μm or more, more preferably 0.05 μm or more, still more preferably 0.1 μm or more, and is preferably 3 μm or less, more preferably 2 μm or less, still more preferably 1 μm or less. If the particle diameter is too small, it may be difficult to control the aggregation rate in the aggregation step, whereas if the particle diameter is too large, the particle diameter of the toner particle obtained by aggregation is likely to become large, and a toner having the objective particle diameter may be hardly obtained.

In the emulsion polymerization suspension method, a known polymerization initiator may be used, if desired, and one polymerization initiator may be used, or two or more polymerization initiators may be used in combination. For example, there is used a persulfate initiator such as potassium persulfate, sodium persulfate or ammonium persulfate; a redox initiator obtained by combining, as one component, the persulfate initiator above with a reducing agent such as acid sodium sulfite; a water-soluble polymerization initiator such as hydrogen peroxide, 4,4′-azobiscyanovaleric acid, tert-butyl hydroperoxide or cumene hydroperoxide; a redox initiator obtained by combining, as one component, the water-soluble polymerization initiator above with a reducing agent such as ferrous salt; benzoyl peroxide, or 2,2′-azobisisobutyronitrile.

Such a polymerization initiator may be added to the polymerization system at any timing, i.e., before addition of the monomer, simultaneously with the addition, or after the addition, and these addition methods may be combined, if desired.

In addition, a known chain transfer agent may be used, if desired. Specific examples thereof include tert-dodecylmercaptan, 2-mercaptoethanol, diisopropyl xanthogen, carbon tetrachloride, and trichlorobromomethane. One chain transfer agent may be used alone, or two or more kinds of chain transfer agents may be used in combination, and the chain transfer agent is used in an amount of 0 to 5 mass % relative to the polymerizable monomer.

Furthermore, a known suspension stabilizer may be used, if desired. Specific examples of the suspension stabilizer include calcium phosphate, magnesium phosphate calcium hydroxide, and magnesium hydroxide, and one of these suspension stabilizers may be used, or two or more thereof may be used in combination. The suspension stabilizer is preferably used in an amount of 1 to 10 parts by mass per 100 parts by mass of the polymerizable monomer.

Both the polymerization initiator and the suspension stabilizer may be added to the polymerization system at any timing, i.e., before addition of the polymerizable monomer, simultaneously with the addition, or after the addition, and these addition methods may be combined, if desired. In addition, a pH adjusting agent, a polymerization degree adjusting agent, a defoaming agent, etc. may be appropriately added to the reaction system.

In the emulsion polymerization aggregation method, a colorant is blended usually in the aggregation step. A dispersion liquid of the primary polymer particle is mixed with a dispersion liquid of the colorant particle to form a mixed dispersion liquid, and this dispersion liquid is subjected to aggregation to form a particle aggregate.

The colorant is preferably used in the state of being dispersed in water in the presence of an emulsifying agent, and the volume average diameter (Mv) of the colorant particle is preferably 0.01 μm or more, more preferably 0.05 μm or more, and is preferably 3 μm or less, more preferably 1 μm or less.

In the case of incorporating a charge-controlling agent into the toner by using the emulsion polymerization aggregation method, the charge-controlling agent may be blended, for example, by a method of adding the charge-controlling agent together with the polymerizable monomer, etc. at the time of emulsion polymerization; a method of adding the charge-controlling agent together with the primary polymer particle, colorant, etc. in the aggregation step; or a method of adding the charge-controlling agent after the primary polymer particle, colorant, etc. are aggregated to reach nearly the objective particle diameter. Among others, the charge-controlling agent is preferably dispersed in water by using a surfactant and added in the aggregation step as a dispersion liquid having a volume average diameter (Mv) of 0.01 to 3 μm.

The aggregation step in the emulsion polymerization aggregation method is performed in a vessel equipped with a stirring device, and there are a method of heating the system, a method of adding an electrolyte, and a method of applying these methods in combination.

In the case of intending to obtain a particle aggregate having the objective size by aggregating primary polymer particles under stirring, the particle diameter of the particle aggregate is controlled by the balance between the cohesive force of particles to each other and the shear force by stirring, and the cohesive force can be increased by heating or by adding an electrolyte.

In the case of performing the aggregation by adding an electrolyte, either an organic salt or an inorganic salt may be used as the electrolyte. Specifically, the electrolyte includes, for example, NaCl, KCl, LiCl, Na₂SO₄, K₂SO₄, Li₂SO₄, MgCl₂, CaCl₂, MgSO₄, CaSO₄, ZnSO₄, Al₂(SO₄)₃, Fe₂(SO₄)₃, CH₃COONa, and C₆H₅SO₃Na. Among these, an inorganic salt having a divalent or higher polyvalent metal cation is preferred.

Assuming that the glass transition temperature of the primary polymer particle is Tg, the aggregation temperature when performing the aggregation only by heating without use of an electrolyte is preferably (Tg-20)° C. or more, more preferably (Tg-10)° C. or more, and is Tg or less, more preferably (Tg-5)° C. or less.

The time required for the aggregation is optimized according to the apparatus configuration or the processing scale, but in order for the particle diameter of the toner to reach the objective particle diameter, the system is preferably held at the predetermined temperature above usually for at least 30 minutes or more. As for the temperature rise to reach the predetermined temperature, the temperature may be raised at a constant rate or may be raised in a stepwise manner.

In the emulsion polymerization aggregation method, the temperature in the ripening step after the aggregation step is preferably from Tg of the primary polymer particle to a temperature higher by 50° C. than Tg but is preferably lower than the melting point of the release agent contained. Thanks to the ripening at a temperature lower than the melting point of the release agent, the release agent can be localized in the vicinity of the surface with neither melting nor existing inside of the toner. The time required for the ripening step varies depending on the objective shape of the toner, but after the temperature reaches the glass transition temperature or more of the primary polymer particle, the system is held for preferably from 0.1 to 10 hours, more preferably from 1 to 6 hours.

Incidentally, it is preferable to add a surfactant or raise the pH value, after the aggregation step, preferably before the ripening step or during the ripening step. As the surfactant used here, one or more members selected from the emulsifying agents usable at the time of production of the primary polymer particle may be used, but use of the same emulsifying agent as that used at the time of production of the primary polymer particle is preferred.

In the case of adding a surfactant, the amount added thereof is not limited but is preferably, per 100 parts by mass of the solid components of the mixed dispersion liquid, 0.1 parts by mass or more, more preferably 1 part by mass or more, still more preferably 3 parts by mass or more, and is preferably 20 parts by mass or less, more preferably 15 parts by mass or less, still more preferably 10 parts by mass or less. There is a case where by adding a surfactant or raising the pH value between after the aggregation step and before the completion of ripening step, the particle aggregates that are aggregated in the aggregation step can be prevented from aggregation, etc. and generation of a coarse particle after the ripening step can be suppressed.

Primary polymer particles in the aggregate are fused/integrated by the heat treatment in the ripening step, and the shape of the toner particle as an aggregate becomes close to sphere. The particle aggregate before the ripening step is thought to be an aggregate resulting from electrostatic or physical aggregation of primary polymer particles, but after the ripening step, the primary polymer particles constituting the particle aggregate are fused to each other, so that the shape of the toner base particle can also be made close to a sphere. According to such a ripening step, by controlling the temperature, time, etc. in the ripening step, the toner base particle can be obtained in various shapes depending on the purpose, for example, with a shape formed by aggregation of primary polymer particles or a spherical shape resulting from further progress of fusion.

### <<Washing of Toner Base Particle>>

The toner base particle obtained by a wet process such as suspension polymerization method, emulsion polymerization aggregation method or dissolution suspension method is preferably washed, if desired, after the obtained toner base particle is taken out from the wet-process medium by solid-liquid separation and the toner particle is recovered as a particle aggregate.

As the liquid used for washing, water having a higher purity than the wet-process medium in which the toner base particle is immersed in the final step of the wet process may be used, or an aqueous acid or alkali solution may be used.

As the acid, an inorganic acid such as nitric acid, hydrochloric acid or sulfuric acid, or an organic acid such as citric acid, may be used.

As the alkali, a sodium salt (e.g., sodium hydroxide, sodium carbonate), a silicic acid salt (e.g., sodium metasilicate), a phosphoric acid salt, etc. may be used.

The washing may be performed at ordinary temperature or under heating to approximately from 30 to 70° C.

By the washing step, a suspension stabilizer, an emulsifying agent, a wet-process medium, an unreacted remaining monomer, a small-diameter toner particle, etc. are removed from the toner base particle. After the washing step, the toner base particle is preferably obtained in a wet cake state by filtration or decantation, because handling in later steps is facilitated. The washing step may be repeated a plurality of times.

<<Step of Removing Water from Toner Base Particle>>

As the dryer used in the water removal step, a fluidized dryer, a jet dryer, a vacuum dryer, etc. may be used. A fluidized dryer where the toner base particle is dried by giving the latent heat of vaporization of water directly to the toner base particle and flowing a gas into the dryer so as to increase the water removal rate, is preferably used. For example, the later-described fluidized dryer with a vibrating device may be used, or a fluidized dryer without a vibrating device may also be used. A fluidized dryer without a vibrating device is more preferably used. With respect to the gas applied to the fluidized dryer, the temperature of the gas, the temperature in the dryer, etc., which are employed in the water removal step, the same gas and the same conditions as those employed in the later-described drying step, such as gas applied to the fluidized dryer with a vibrating device, temperature of the gas, and temperature in the dryer, may be applied.

### <<Drying of Toner Base Particle>>

In the step of drying the toner base particle, a dryer such as fluidized dryer, jet dryer or vacuum dryer may be used. Among others, the toner base particle is preferably dried by a fluidized dryer with a vibrating device. In the fluidized dryer with a vibrating device, the toner base particle can be rapidly dried by flowing a gas into the dryer main body and also utilizing the latent heat of vaporization of water contained in the toner base particle. In addition, vibration is imparted to the toner base particles by the vibrating device, whereby not only the toner base particle can be fluidized even when the flow rate of the gas is reduced, but also an aggregated material accumulating on the bottom can be disaggregated, making it possible to rapidly and efficiently dry the toner base particle.

Drying is preferably performed at ordinary pressure or under reduced pressure. Drying is more preferably performed at ordinary pressure, because the quantity of heat that can be given to the toner base particle by the gas becomes small under reduced pressure.

<Production Method of Toner Base Particle, which is Characteristic Feature of the Present Invention>

The present invention is also a production method of the toner base particle described above, i.e., a method for producing a toner base particle having a core-shell structure and having a shape factor of 150 or more, which is obtained by attaching, as a shell, a resin fine particle containing at least a release agent to the surface of a core particle containing at least a binder resin and a colorant, the production method of a toner base particle including incorporating a release agent into the resin fine particle in an amount of 20 to 50 mass % relative to the entirety of the resin fine particle.

In the production method, the release agent is incorporated into the resin fine particle preferably in an amount of 10 to 50 mass %, more preferably from 20 to 50 mass %, relative to the entirety of the resin fine particle.

When the lower limit and upper limit satisfy the values above, a toner base particle of embodiment 1 and/or embodiment 2 having the above-described effects of the present invention can be produced.

The method for producing a toner base particle having a core-shell structure and having a shape factor of 150 or more, i.e., having irregularities (derived from a resin fine particle, etc.) on the toner base particle surface, the production method including incorporating a release agent into the rein fine particle in an amount of 20 to 50 mass % relative to the entirety of the resin fine particle, has not been conventionally known.

Particularly, in either embodiment 1 or embodiment 2 of the present invention, the toner base particle is preferably produced by incorporating a release agent into a shell-forming resin fine particle, in an amount of 20 to 50 mass % relative to the entirety of the resin fine particle.

In the production method of a toner base particle, the core particle preferably contains no release agent. That is, the production method of forming a shell on the surface of a core particle not containing a release agent is advantageous in that, as in embodiments 1 and 2, an appropriate amount of a release agent can be localized in the vicinity of the toner base particle surface to satisfy both the storage stability and the low-temperature fixability.

In the production method of a toner base particle, the resin fine particle is preferably attached to the core particle surface in an amount of 5 to 25 mass % relative to the total amount of the core particle and the resin fine particle, so that, as in embodiments 1 and 2, an appropriate amount of a release agent can be present near the surface of the toner base particle. In addition, the range above is also preferred from the standpoint of ensuring the low-temperature fixability and satisfying both the storage stability and low-temperature fixability. The resin fine particle is more preferably attached in an amount of 10 to 20 mass %.

The production method of a toner base particle, where the temperature at the time of adding the resin fine particle to form a shell on the surface of the core particle (hereinafter, simply referred to as “ripening temperature”) is set to a temperature range from the glass transition temperature (Tg) of the core particle to the glass transition temperature (Tg) of the shell-forming resin fine particle, is preferred for the below-described reason.

In order to form the toner base particle in round shape, the ripening temperature is preferably set to be higher by 15° C. or more, more preferably by 25° C. or more, than Tg of the core particle.

In addition, for suppressing compatibilization of the core particle and the shell, preventing the shell from plasticization (for example, the shell becomes uneven and does not successfully cover the core particle, or the shell is reduced in the thickness), and in turn, allowing for no deterioration of the blocking resistance, the ripening temperature is preferably set to be lower by 10° C. or more than Tg of the resin fine particle.

The production method of a toner base particle, where the glass transition temperature (Tg) of the shell-forming resin fine particle is set to be higher by 25° C. or more than the glass transition temperature (Tg) of the core particle, is preferred for the blow-described reason.

If the difference between Tg of the core particle and Tg of the shell is less than 25° C., that is, if the difference in Tg is too small, the temperature region where the core particle and the shell are not compatibilized is narrowed, and the optimal ripening temperature range becomes narrow, as a result, a toner particle having a distinct core-shell structure may not be produced.

The temperature difference between Tg of the core particle and Tg of the shell is preferably 20° C. or more, more preferably 30° C. or more, still more preferably 35° C. or more.

When a release agent is localized in the vicinity of the surface so as to effectively exert the release effect, the release agent is highly probably exposed on the outermost surface of the toner base particle, and due to such a free release agent in the surface, an image defect such as filming, blurring and fogging is often induced at the time of printing.

However, in the present invention, the release agent is caused to exist in the resin fine particle in the state of being covered with a resin thin film by performing seed polymerization of adding the release agent at the time of polymerization of the resin fine particle for shell and therefore, even in the surface of a toner base particle where the release agent is present in the shell, the release agent is not allowed to exist in the state of being exposed on the toner base particle surface, as a result, the fear of adverse effect on the toner performance is eliminated.

The toner base particle of the present invention is preferably produced by an emulsion polymerization aggregation method; the core-shell structure is more preferably formed by attaching a resin fine particle to a core particle; and the fine particle is still more preferably prepared by performing seed polymerization by using the release agent as a seed.

<Effects, Etc. Of Toner Base Particle of the Present Invention and Production Method of the Toner Base Particle>

In the conventional toner base particle where a release agent is incorporated into the shell, Tg of the shell-forming resin fine particle is set to be as low as possible so as to form a round shape at a low temperature.

However, it has been discovered that when the temperature (in the present invention, sometimes simply referred to as “ripening temperature”) at the time of adding the resin fine particle to form a shell on the surface of the core particle (hereinafter, sometimes simply referred to as “ripening”) is set to a temperature range from Tg of the core particle to Tg of the shell-forming resin fine particle, even if a resin fine particle having a high Tg is used, the circularity can be increased unexpectedly.

That is, it has been found that when the temperature is set to descend in order of Tg of the core particle, the ripening temperature and Tg of the resin fine particle forming the shell (Tg of shell), even if a resin fine particle having a high Tg is used, the circularity of the toner base particle can be increased.

In this case, the resin fine particle merely sticks to the core particle surface without melting at the ripening temperature, and only the core particle portion moves to form a round shape.

In the toner base particle of the present invention, the resin fine particle forms a shell but is not completely mixed with the core particle and remains on the core particle surface.

As shown in FIG. 2, irregularities or “bumps” derived from the resin fine particle are observed on the surface of the toner base particle. In the present invention, this shape is specified by “the toner base particle has a shape factor of 150 or more”.

If the ripening temperature is higher than Tg of the resin fine particle, the shell material is melted and compatibilized with the core particle to raise Tg of the entire toner base particle and therefore, formation in round shape may be inhibited or the proportion of the resin fine particle present in the surface of the toner base particle may be reduced. As a result, the location of the release agent contained in the resin fine particle may not be concentrated in the vicinity of the surface of the toner base particle, and embodiment 1 or embodiment 2 may not be realized.

In addition, if the ripening temperature is higher than Tg of the resin fine particle, the shell is depopulated (for example, the shell becomes uneven and does not successfully cover the core particle, or the shell is reduced in the thickness) and therefore, the storage stability of the toner may be deteriorated.

Furthermore, due to mixing of the core particle with the shell, Tg of the entire toner base particle rises (i.e., Tg of the toner rises) and therefore, the low-temperature fixability may be changed for the worse. An example of such a toner particle is depicted in FIG. 3.

In particular, it is more preferred that not only the ripening temperature is not more than Tg of the resin fine particle but also the ripening temperature is not more than the melting point of the release agent, because the toner base particle according to the embodiment of the present invention can be suitably produced and the above-described effects of the present invention are exerted.

In the above-described production method, a resin fine particle containing a large amount of a releasing agent and having a high Tg can be caused to stick to the core particle surface and arranged in the outermost wall of the toner base particle, making it easy to balance the low-temperature fixability and the blocking resistance, and the effects of the present invention are exerted.

### <External Addition to Toner Base Particle>

Next, an external additive is externally added to the toner base particle, and a toner is formed by attaching or fixing the external additive to the toner base particle surface. The toner of the present invention is a toner that the external additive is externally added to the toner base particle. The external additive includes those described above.

As the method for externally adding an external additive to the toner base particle, a technique of adding an external additive to a system having charged thereinto a toner base particle, followed by stirring and mixing, is employed. For the stirring/mixing of the toner base particle and the external additive, a device for mechanical rotation treatment is preferably used. Specifically, a rotary mixing machine such as Henschel mixer is suitably used.

The speed (peripheral speed) at the tip of the stirring blade in the external addition treatment using such a device is preferably from 21.2 to 95.5 m/sec, more preferably from 38.2 to 76.4 m/sec. Burying the external additive in a colored particle by this stirring/mixing treatment can be regulated by adjusting the rotation speed, as a result, the flowability of the toner obtained can be controlled.

The toner of the present invention preferably has a configuration where an external additive is uniformly attached to the toner particle surface. Different kinds of external additives may be treated by adding each external additive in one stage or in two or more stages, whereby the external additives can be uniformly attached to the toner base particle surface. External addition is preferably performed by adding and mixing an external additive having a small particle diameter and then adding and mixing an external additive having a large particle diameter.

The stirring time in the stirring/mixing treatment is not particularly limited and may be determined according to the stirring speed, etc. In addition, the temperature at the time of external addition is not particularly limited but is preferably from 25 to 55° C., more preferably from 30 to 50° C.

### <Prescriptions Relating to Electrostatic Image Developing Toner>

Although the prescriptions relating to the toner base particle are described in the foregoing pages, a toner where the particle after removing the external additive from the externally added electrostatic image developing toner (toner) by the following “External Agent Removing Method A” satisfies the above-described “prescriptions relating to the toner base particle”, exerts the effects of the present invention as the toner and is preferred.

That is, the present invention is also an electrostatic image developing toner obtained by externally adding an external additive to a toner base particle, wherein a toner base particle after dispersing the electrostatic image developing toner in water and removing the external additive by using an external additive removing method A of applying an ultrasonic wave in the presence of a nonionic surfactant is the toner base particle described above.

Here, the “external additive removing method A” is defined as follows.

### <<External Additive Removing Method A>>

A beaker is charged with 5 g of the toner and 40 mL of a 1.2% aqueous solution of “Triton X-100” as a nonionic surfactant, and the mixture is stirred by a stirring machine for 5 minutes.

The energy of an ultrasonic wave homogenizer is set to 12 Id, and an ultrasonic wave thereof is applied.

The solution above is transferred to a centrifugal precipitation tube, centrifuged for 3 minutes by a centrifugal separator (646G) and then left standing still.

Thereafter, the supernatant is discarded, 45 mL of desalted water is added to the residue, the mixture is treated in a test tube mixer for 20 seconds, and the precipitated particles are again dispersed in water.

The dispersion is centrifuged for 3 minutes by a centrifugal separator (646G), the supernatant is discarded, 45 mL of desalted water is added to the residue, the mixture is treated in a test tube mixer for 20 seconds, and the precipitated particles are again dispersed in water (i.e., this operation is repeated twice).

Subsequently, the dispersion is centrifuged for 3 minutes by a centrifugal separator (646G) and left standing still, and the supernatant is discarded.

10 mL of desalted water is added to the residue, the precipitated particles are disaggregated, and the solution is suction-filtered through filter paper 5C produced by Whatman.

The particle filtered is dried at 40° C. for 8 hours by using a dryer.

The “particle” above after removing the external additive from the toner by using the external additive removing method A is regarded as the “toner base particle”, and a toner satisfying the above-described requirements produces the effects of the present invention.

The present invention is also an electrostatic image developing toner obtained by externally adding an external additive to the toner base particle above.

### <Toner Cartridge>

It is also preferred that the toner of the present invention is supplied in the form of a toner cartridge.

The toner cartridge has a developing roller for supporting a toner, a charging blade (charging member) disposed on the upper side of the developing roller, a retaining blade disposed on the lower side of the developing roller to face the developing roller via a predetermined distance, and the electrostatic image developing toner described above.

According to the toner cartridge having loaded therein the toner of the present invention, since the toner base particle of the present invention and the toner of the present invention are used, the above-described effects are exerted.

### EXAMPLES

The present invention is described more specifically below, but the present invention is not limited to the following Examples as long as the gist thereof is observed. In examples below, “parts” means “parts by mass”.

The particle diameter, average circularity, electrical conductivity, etc. of each of the toner base particle and the toner were measured as follows.

### <Method for Measuring Volume Average Diameters (Mv) of Primary Polymer Particle in Primary Polymer Particle Dispersion Liquid and Release Agent Dispersion in Release Agent Dispersion Liquid>

The volume average diameter (Mv) of a particle having a volume average particle (Mv) of less than 1 μm was measured by means of Model: Microtrac Nanotrac 150 (hereinafter, simply referred to as “Nanotrac”) manufactured by Nikkiso Co., Ltd. and an analysis software, Microtrac Particle Analyzer Ver 10.1.2.-019EE, produced by the same company by the method described in the instruction manual by using, as the solvent, ion-exchanged water having ion conductivity of 0.5 μS/cm under the measurement conditions of solvent refractive index: 1.333, measurement time: 600 seconds and number of measurements: 1.

Other conditions were set to particle refractive index: 1.59, transmissivity: transparent, shape: truly spherical, and density: 1.04.

### <Measurement Method and Definition of Volume Median Diameter (Dv50) of Toner Base Particle and Toner>

The toner base particle or toner (hereinafter, simply referred to as “sample”) was treated as follows as a treatment before measurement.

That is, a cylindrical polyethylene (PE)-made beaker having an inner diameter of 47 mm and a height of 51 mm was added with 0.100 g of the sample by means of a spatula and 0.15 g of an aqueous 20 mass % DBS solution (NEOGEN S-20A, produced by Dai-ichi Kogyo Seiyaku Co., Ltd.) (hereinafter, simply referred to as “aqueous 20% DBS solution”) by means of a dropper. At this time, in order to avoid scattering of the toner to the rim, etc. of the beaker, the sample and the aqueous 20% DBS solution were put only in the bottom of the beaker.

Next, the sample and the aqueous 20% DBS solution were stirred for 3 minutes by means of a spatula until turned into a paste. Also at this time, care was taken to allow for no scattering of the toner to the rim, etc. of the beaker.

Subsequently, 30 g of a dispersion medium Isoton II was added, and the mixture was stirred for 2 minutes by means of a spatula to form an entirely uniform solution as visually observed.

A fluororesin-coated rotor having a length of 31 mm and a diameter of 6 mm was then put in the beaker, and the solution was dispersed at 400 rpm for 20 minutes by means of a stirrer. At this time, macroscopic particles as visually observed at the air-liquid interface and the rim of the beaker were caused to fall into the inside of the beaker by means of a spatula at a rate of once each three minutes and treated to form a uniform dispersion liquid.

Thereafter, the dispersion liquid was filtered through a mesh having an opening of 63 μm, and the obtained filtrate was designated as “sample dispersion liquid”.

As to the measurement of the volume median diameter (Dv50) of the toner base particle, the measurement can also be performed in the production process of the toner base particle. In this case, the filtrate obtained by filtering the slurry during aggregation through a mesh of 63 μm was designated as “slurry liquid”.

The volume median diameter (Dv50) of the particle was measured by means of Multisizer III manufactured by Beckman Coulter K.K. (aperture diameter: 100 μm) (hereinafter, simply referred to as “Multisizer”) by using, as the dispersion medium, Isoton II produced by the same company and diluting the “sample dispersion liquid” or “slurry liquid” to afford a dispersoid concentration of 0.03 mass %, where a Multisizer III analysis software was used and the KD value was set to 118.5.

The particle diameter was measured in a range from 2.00 to 64.00 μm and after this range was discretized into 256 divisions at equal intervals on a logarithmic scale, the value calculated from their statistical values on the volume basis was defined as “volume median diameter (Dv50)”.

Hereinafter, the volume median diameter (Dv50) is sometimes simply referred to as “Dv50”, “volume median diameter (Dv)” or “Dv”.

### <Measurement Method and Definition of Average Circularity>

In the present invention, the “average circularity” is measured as follows and defined as follows. That is, toner base particles were dispersed in a dispersion medium (Particle Sheath, produced by SYSMEX Corporation) to afford a concentration of 5,720 to 7,140 particles/μL and measured by means of a flow-type particle image analyzer (FPIA3000, manufactured by SYSMEX Corporation) under the following apparatus conditions, and the obtained value is defined as the “average circularity”. In the present invention, the same measurement is performed three times, and the arithmetic average value of three “average circularity” values is employed as the “average circularity”.

Mode: HPF

HPF Analysis amount: 0.35 μL

Number of particles detected by HPF: 8,000 to 10,000

The followings are values determined by the apparatus above and displayed thereon through automatic calculation made in the apparatus, but the “circularity” is defined by the following formula:

[Circularity]=[circumferential length of circle having the same area as the projected area of particle]/[circumferential length of the projected image of particle]

From 8,000 to 10,000 particles as the number of particles detected by HPF were measured, and the arithmetic average (arithmetic mean) of the circularity values of individual particles is displayed on the apparatus as the “average circularity”.

### <Measurement Method of Electrical Conductivity>

The electrical conductivity was measured using a conductivity meter (Personal SC Meter Model SC72 and Detector SC72SN-11, manufactured by Yokogawa Electric Corporation).

<Method for Measuring Number of Toner Base Particles of 0.8 to 3.0 μm>

As for the “number of toner base particles of 0.8 to 3.0 μm”, the number of particles was measured using the same apparatus (flow-type particle image analyzer) as in <Measurement Method and Definition of Average Circularity> above base on the specs of the apparatus. Subsequently, the ratio (%) of the number of particles to the number of all toner base particles was calculated.

### <Measurement of Cross-Section of Toner Base Particle and Toner>

The mass of the release agent contained outside or inside of an approximate oval sphere and the ratio to the mass of all release agents in the toner base particle were measured by the above-described method in accordance with the definition of an approximate ellipse or an approximate oval sphere described in <<Definitions of Approximate Ellipse and Approximate Oval Sphere>> (embodiment 1).

In addition, the mass of the release agent in the shell and the ratio to the mass of all release agents in the toner base particle were measured by the above-described method.

That is, after a toner base particle or a toner was embedded and fixed in an epoxy resin, an ultrathin section was prepared using a cryoultramicrotome.

The obtained ultrathin section was stained with ruthenium tetroxide and observed using TEM.

An image is incorporated for the image analysis and with respect to 50 or more “cross-sectional images where the long diameter of the cross-section is 80% or more of the volume median diameter (Dv) of the toner base particle” that is regarded as being cut near the center of the particle, the measurement of surface area of the cross-section and the quantitative determination of the release agent present outside of the approximate ellipse and/or in the shell portion were performed.

### <Measurement of Shape Factor>

The “shape factor” was calculated based on “SF2” measured by the above-described method according to the definition described in <<<Definition of Shape Factor>>>.

That is, an SEM image at a magnification of 5,000 of the toner base particle was incorporated for the image analysis and after SF2 was determined according to the following formula, the arithmetic average value of SF2 of 50 or more toner particles was obtained and defined as the “shape factor”.

SF2=100×[projected circumferential length of toner base particle]²/(4π×[projected area of toner base particle])

### <Measurement of BET Specific Surface Area>

The BET specific surface area was measured in a conventional manner by means of MacSorb 1208 manufactured by Mountech Co., Ltd. The sample amount was 0.50 g, and a helium/nitrogen mixed gas was used.

### <Detection of Release Agent Content in Toner Base Particle>

The endothermic amount of the release agent was measured from the peak at 66.8 to 86.2° C. obtained by DSC measurement in the range of 40 to 200° C. (temperature rise: 10° C./min), and the content of the release agent was calculated using a calibration curve.

<Measurement Method of Storage Stability (Blocking Resistance)>

In order to examine the thermal stability of the toner, a consolidation test was performed as follows by using toner base particles of Experimental Examples 1 to 8 before external addition.

That is, a cylindrical container having an inner diameter of 15 mm and a length of 80 mm was erected on an iron-made plate, and paraffin paper was wound onto the inside of the cylinder. Thereafter, 10 g of the toner base particle passed through a 500 mesh sieve was charged into the cylinder, and a sample vial (diameter: 15 mm) adjusted to 20 g by putting a weight on the top was slowly placed thereon. The cylindrical container with the plate was lifted up, put inside of a thermo-hygrostat (50° C., 40%) and held for 24 hours.

After taking it out, the weight, paraffin paper and cylindrical container were removed, and an agglomerate of toner base particles was taken out. Weights were sequentially placed thereon, and the amount of weight when the toner agglomerate is disintegrated was measured.

The blocking resistance was judged according to the following criteria. The results are shown in Table 1.

### [Judgment Criteria of Blocking Resistance]

AA (Good): Particles are consolidated, but the agglomerate is disintegrated under a load of less than 50 g.

A (Practicable): Particles are consolidated, but the agglomerate is disintegrated under a load of 50 g to less than 100 g.

B (Insufficient): Particles are consolidated, and the agglomerate is disintegrated under a load of 100 g to less than 200 g.

C (Unusable): Particles are consolidated, and the agglomerate is not disintegrated unless a load of 200 g or more is applied.

### <Fixing Test>

### <<Measurement Method and Definition of Fixing Temperature Region>>

Recording paper carrying an unfixed toner image was prepared and conveyed to a fixing nip part by changing the surface temperature of heated rollers in steps of 5° C. from 100° C. to 215° C., and the fixing state when discharged at a speed of 150 mm/sec was observed.

The temperature region where toner offset or paper winding is not caused on the heated rollers during fixing and the toner on the recording paper after fixing is sufficiently adhered to the recording paper was defined as “fixing temperature region”.

In the heated roller of the fixing machine, the release layer is formed of PFA (tetrafluroethylene-perfluoroalkyl vinyl ether copolymer), and the evaluation was performed without applying silicone oil.

In the measurement method above, an actual printing test was performed by using toners obtained after external addition to the toner base particles of Experimental Examples 1 to 8 and setting the roller temperature to 210° C., and the obtained image was judged with an eye according to the following criteria, whereby the “low-temperature fixability” and “high-temperature fixability” were determined. The results are shown in Table 1.

### [Judgment Criteria of High-Temperature Fixability]

AA: Good; utterly no problem.

A: Practicable; a release failure is slightly observed, but no problem.

B: Insufficient; the release failure is conspicuous.

C: Unusable; a serious release failure is generated.

### <<Measurement Method and Definition of Low-Temperature Fixability>>

In the measurement method above, an actual printing test was performed in the same manner by setting the roller temperature to 135° C. and after rubbing the obtained fixed image under a given load, the reduction in the density between before and after rubbing was judged with an eye according to the following criteria, whereby the “low-temperature fixability” was decided. The results are shown in Table 1.

### [Judgment Criteria of Low-Temperature Fixability]

AA: Good; no reduction in density.

A: Practicable; reduction in density is slightly observed.

B: Insufficient; reduction in density is conspicuous.

C: Unusable; the image is mostly peeled off.

### Preparation Example

### Preparation of Release Agent Dispersion Liquid A1

27.3 Parts of Release Agent 1 (HNP-9 (produced by Nippon Seiro Co., Ltd., melting point: 76.0° C.), 2.7 parts of stearyl acrylate monomer, 2.8 parts of an aqueous 20% sodium dodecylbenzenesulfonate solution (NEOGEN S20D, produced by Dai-ichi Kogyo Seiyaku Co., Ltd) (hereinafter, simply referred to as “aqueous 20% DBS solution”), and 67.3 parts of desalted water were added, and the mixture was heated to 100° C. and subjected to primary circulating emulsification under pressurized condition of 10 MPa by using a homogenizer with a pressurized circulation line (Model LAB60-10TBS, manufactured by Gaulin Company).

The particle diameter was measured by LA950 every a few minutes. When the median diameter was decreased to around 500 nm, the pressure condition was elevated to 25 MPa, and secondary circulating emulsification was performed successively. The dispersion was continued until the median diameter becomes 230 nm or less, whereby Release Agent Dispersion Liquid A1 was produced.

The volume average diameter (Mv) of the release agent dispersion in Release Agent Dispersion Liquid A1 was 215 nm.

### <Preparation of Primary Polymer Particle Dispersion Liquid B1> (for Core)

A reaction vessel equipped with a stirring device (three blades), a heating/cooling device, a concentrating device and a device for charging each raw material or adjuvant was charged with 239 parts of desalted water and 0.8 parts of an aqueous 20% DBS solution, and the temperature was raised to 90° C. in a nitrogen stream while stirring the mixture.

Thereafter, while continuously stirring the solution above, 3.2 parts of an aqueous 8 mass % hydrogen peroxide solution and 3.2 parts of an aqueous 8 mass % L(+)-ascorbic acid solution were added, and from 5 minutes after, a mixture of the following “polymerizable monomers, etc.” and “aqueous emulsifying agent solution” was added thereto over 5 hours.

The time at which the dropwise addition of the mixture was started was taken as “polymerization initiation”, and simultaneously with the polymerization initiation, the following “aqueous initiator solution” was added over 5 hours. Furthermore, the following “additional aqueous initiator solution” was added over 2 hours from 5 hours after the polymerization initiation and at the same time, the temperature was raised to an internal temperature of 95° C. The system was kept stirring and held for 2 hours.

### [Polymerizable Monomers, etc.]

Styrene: 65.5 parts

Butyl acrylate: 34.5 parts

Acrylic acid: 0.7 parts

Hexanediol diacrylate: 0.7 parts

Trichlorobromomethane: 0.5 parts

### [Aqueous Emulsifying Agent Solution]

Aqueous 20% DBS solution: 1.0 parts

Desalted water: 66.6 parts

### [Aqueous Initiator Solution]

Aqueous 8 mass % hydrogen peroxide solution: 15.7 parts

Aqueous 8 mass % L(+)-ascorbic acid solution: 15.7 parts

### [Additional Aqueous Initiator Solution]

Aqueous 8 mass % L(+)-ascorbic acid solution: 14.2 parts

After the completion of polymerization reaction, the reaction mixture was cooled to obtain milky-white Primary Polymer Particle Dispersion Liquid B1. The volume average diameter (Mv) as measured by Nanotrac was 183 nm, and the solid content concentration was 22.8 mass %.

### <Preparation of Primary Polymer Particle Dispersion Liquid C1> (for Shell)

A reaction vessel equipped with a stirring device (three blades), a heating/cooling device, a concentrating device and a device for charging each raw material or adjuvant was charged with 109.3 parts of Release Agent Dispersion Liquid A1 and 279 parts of desalted water, and the temperature was raised to 90° C. in a nitrogen stream while stirring the mixture.

Thereafter, while continuously stirring the solution above, a mixture of the following “polymerizable monomers, etc.” and “aqueous emulsifying agent solution” was added thereto over 5 hours.

The time at which the dropwise addition of the mixture was started was taken as “polymerization initiation”, and the following “aqueous initiator solution” was added over 4.5 hours from 30 minutes after the polymerization initiation. Furthermore, the following “additional aqueous initiator solution” was added over 2 hours from 5 hours after the polymerization initiation, and the system was kept stirring and held at an internal temperature of 90° C. for 1 hour.

### [Polymerizable Monomers, etc.]

Styrene: 98.0 parts

Butyl acrylate: 2.0 parts

Acrylic acid: 1.5 parts

Hexanediol diacrylate: 0.7 parts

Trichlorobromomethane: 1.0 parts

### [Aqueous Emulsifying Agent Solution]

Aqueous 20% DBS solution: 1.0 parts

Desalted water: 67.1 parts

### [Aqueous Initiator Solution]

Aqueous 8 mass % hydrogen peroxide solution: 15.5 parts

Aqueous 8 mass % L(+)-ascorbic acid solution: 15.5 parts

### [Additional Aqueous Initiator Solution]

Aqueous 8 mass % L(+)-ascorbic acid solution: 14.2 parts

After the completion of polymerization reaction, the reaction mixture was cooled to obtain milky-white Primary Polymer Particle Dispersion Liquid C 1. The volume average diameter (Mv) as measured by Nanotrac was 214 nm, and the solid content concentration was 22.9 mass %.

### <Preparation of Primary Polymer Particle Dispersion Liquid C2> (for Shell)

Primary Polymer Particle Dispersion Liquid C2 was obtained by the same method as Primary Polymer Particle Dispersion Liquid C1 except for changing the charge amount of Release Agent Dispersion Liquid A1 to 255 parts and the charge amount of desalted water to 319 parts.

The volume average diameter (Mv) as measured by Nanotrac was 218 nm, and the solid content concentration was 23.8 mass %.

### <Preparation of Primary Polymer Particle Dispersion Liquid B2> (for Core/Shell)

A reaction vessel equipped with a stirring device (three blades), a heating/cooling device, a concentrating device and a device for charging each raw material or adjuvant was charged with 35.3 parts of Release Agent Dispersion Liquid A1 and 260 parts of desalted water, and the temperature was raised to 90° C. in a nitrogen stream while stirring the mixture.

Thereafter, while continuously stirring the solution above, a mixture of the following “polymerizable monomers, etc.” and “aqueous emulsifying agent solution” was added thereto over 5 hours.

The time at which the dropwise addition of the mixture was started was taken as “polymerization initiation”, and the following “aqueous initiator solution” was added over 4.5 hours from 30 minutes after the polymerization initiation. Furthermore, the following “additional aqueous initiator solution” was added over 2 hours from 5 hours after the polymerization initiation, and the system was kept stirring and held at an internal temperature of 90° C. for 1 hour.

### [Polymerizable Monomers, etc.]

Styrene: 76.8 parts

Butyl acrylate: 23.2 parts

Acrylic acid: 1.5 parts

Hexanediol diacrylate: 0.7 parts

Trichlorobromomethane: 1.0 parts

### [Aqueous Emulsifying Agent Solution]

Aqueous 20% DBS solution: 1.0 parts

Desalted water: 67.1 parts

### [Aqueous Initiator Solution]

Aqueous 8 mass % hydrogen peroxide solution: 15.5 parts

Aqueous 8 mass % L(+)-ascorbic acid solution: 15.5 parts

### [Additional Aqueous Initiator Solution]

Aqueous 8 mass % L(+)-ascorbic acid solution: 14.2 parts

After the completion of polymerization reaction, the reaction mixture was cooled to obtain milky-white Primary Polymer Particle Dispersion Liquid B2. The volume average diameter (Mv) as measured by Nanotrac was 241 nm, and the solid content concentration was 20.25 mass %.

### <Preparation of Primary Polymer Particle Dispersion Liquid C3> (for Shell)

A reaction vessel equipped with a stirring device (three blades), a heating/cooling device, a concentrating device and a device for charging each raw material or adjuvant was charged with 109.3 parts of Release Agent Dispersion Liquid A1 and 279 parts of desalted water, and the temperature was raised to 90° C. in a nitrogen stream while stirring the mixture.

Thereafter, while continuously stirring the solution above, a mixture of the following “polymerizable monomers, etc.” and “aqueous emulsifying agent solution” was added thereto over 5 hours.

The time at which the dropwise addition of the mixture was started was taken as “polymerization initiation”, and the following “aqueous initiator solution” was added over 4.5 hours from 30 minutes after the polymerization initiation. Furthermore, the following “additional aqueous initiator solution” was added over 2 hours from 5 hours after the polymerization initiation, and the system was kept stirring and held at an internal temperature of 90° C. for 1 hour.

### [Polymerizable Monomers, etc.]

Styrene: 76.8 parts

Butyl acrylate: 23.2 parts

Acrylic acid: 1.5 parts

Hexanediol diacrylate: 0.7 parts

Trichlorobromomethane: 1.0 parts

### [Aqueous Emulsifying Agent Solution]

Aqueous 20% DBS solution: 1.0 parts

Desalted water: 67.1 parts

### [Aqueous Initiator Solution]

Aqueous 8 mass % hydrogen peroxide solution: 15.5 parts

Aqueous 8 mass % L(+)-ascorbic acid solution: 15.5 parts

### [Additional Aqueous Initiator Solution]

Aqueous 8 mass % L(+)-ascorbic acid solution: 14.2 parts

After the completion of polymerization reaction, the reaction mixture was cooled to obtain milky-white Primary Polymer Particle Dispersion Liquid C3. The volume average diameter (Mv) as measured by Nanotrac was 240 nm, and the solid content concentration was 22.7 mass %.

### <Preparation of Primary Polymer Particle Dispersion Liquid C4> (for Shell)

A reaction vessel equipped with a stirring device (three blades), a heating/cooling device, a concentrating device and a device for charging each raw material or adjuvant was charged with 255.1 parts of Release Agent Dispersion Liquid A1 and 319 parts of desalted water, and the temperature was raised to 90° C. in a nitrogen stream while stirring the mixture.

Thereafter, while continuously stirring the solution above, a mixture of the following “polymerizable monomers, etc.” and “aqueous emulsifying agent solution” was added thereto over 5 hours.

The time at which the dropwise addition of the mixture was started was taken as “polymerization initiation”, and the following “aqueous initiator solution” was added over 4.5 hours from 30 minutes after the polymerization initiation. Furthermore, the following “additional aqueous initiator solution” was added over 2 hours from 5 hours after the polymerization initiation, and the system was kept stirring and held at an internal temperature of 90° C. for 1 hour.

### [Polymerizable Monomers, etc.]

Styrene: 88.0 parts

Butyl acrylate: 12.0 parts

Acrylic acid: 1.5 parts

Hexanediol diacrylate: 0.7 parts

Trichlorobromomethane: 1.0 parts

### [Aqueous Emulsifying Agent Solution]

Aqueous 20% DBS solution: 1.0 parts

Desalted water: 67.1 parts

### [Aqueous Initiator Solution]

Aqueous 8 mass % hydrogen peroxide solution: 15.5 parts

Aqueous 8 mass % L(+)-ascorbic acid solution: 15.5 parts

### [Additional Aqueous Initiator Solution]

Aqueous 8 mass % L(+)-ascorbic acid solution: 14.2 parts

After the completion of polymerization reaction, the reaction mixture was cooled to obtain milky-white Primary Polymer Particle Dispersion Liquid C4. The volume average diameter (Mv) as measured by Nanotrac was 232 nm, and the solid content concentration was 23.4 mass %.

### Example 1

A toner base particle was produced according to the following procedure by using respective component in Recipe 1 below.

### <Recipe 1>

<Particle Growth Process>

| | |
|---|---|
| Primary Polymer Particle Dispersion Liquid | 80 parts as solid content |
| B1 (for core) | |
| Primary Polymer Particle Dispersion Liquid | 20 parts as solid content |
| C1 (for shell) | |
| Colorant (Pigment Blue 15:3) dispersion | 4.4 parts as colorant solid |
| liquid | content |
| Aqueous 20% DBS solution | 0.1 parts as solid content |
| Aqueous 5% ferrous sulfate solution | 0.52 parts as solid content |
| Aqueous 0.5 mass % aluminum sulfate | 0.2 parts as solid content |
| solution | |

<Round Shape Forming Step>

| | |
|---|---|
| Aqueous 20% DBS solution | 4.0 parts as solid content |

Primary Polymer Particle Dispersion Liquid B1 (for core) and an aqueous 20% DBS solution were charged into a mixing vessel (volume: 12 L, inner diameter: 208 mm, height: 355 mm) equipped with a stirring device (double helical blade), a heating/cooling device, a concentrating device and a device for charging each raw material or adjuvant and uniformly mixed for 5 minutes at an internal temperature of 12° C.

Subsequently, while continuously stirring the mixture at an internal temperature of 12° C., an aqueous 5% ferrous sulfate solution was added over 5 minutes, and a colorant dispersion liquid was added over 5 minutes. The resulting solution was uniformly mixed at an internal temperature of 12° C., and an aqueous 0.5% aluminum sulfate solution was further added dropwise under the same conditions.

Thereafter, the internal temperature was raised to 37° C. at 0.8° C./min and further raised to 38.7° C. over 200 minutes. Here, the volume median diameter (Dv50) was measured by means of Multisizer and found to be from 6.00 to 6.10 μm.

Furthermore, Primary Polymer Particle Dispersion Liquid B2 (for shell) was added over about 20 minutes, and the system was held as-is for 60 minutes. After adding an aqueous 20% DBS solution over 10 minutes, the temperature was raised to 74.8° C. over 60 minutes, and the system was held at the same temperature until the average circularity as measured by FPIA3000 became 0.960. Thereafter, the reaction mixture was cooled to 30° C. over 30 minutes to obtain a slurry.

This slurry was suction-filtered by means of an aspirator through filter paper of class 5 C (No5C, manufactured by Toyo Roshi Kaisha, Ltd.). The cake remaining on the filter paper was transferred to a stainless steel vessel with a stirrer (propeller blade), which has an internal volume of 10 L, and after adding 8 kg of ion-exchanged water with an electrical conductivity of 1 μS/cm, uniformly dispersed by stirring at 50 rpm, and the resulting dispersion was kept stirring for another 30 minutes.

The resulting dispersion was again suction-filtered by means of an aspirator through filter paper of class 5 C (No5C, manufactured by Toyo Roshi Kaisha, Ltd.). The solid material remaining on the filter paper was again transferred to a vessel equipped with a stirrer (propeller blade), which has an internal volume of 10 L and contains 8 kg of ion-exchanged water with an electrical conductivity of 1 μS/cm, and uniformly dispersed by stirring at 50 rpm, and the resulting dispersion was kept stirring for 30 minutes. This process was repeated five times, as a result, the electrical conductivity of the filtrate became 2 μS/cm.

The cake obtained here was spread on a stainless steel-made vat to a height of 20 mm and dried for 48 hours in a blow dryer set to 40° C. to obtain a toner base particle.

A 9 L Henschel mixer manufactured by Mitsui Mining Co., Ltd. was charged with 100 parts (500 g) of the obtained toner base particle and subsequently, 2.0 parts of a silica fine particle having a volume average primary particle diameter of 0.10 μm and being subjected to a hydrophobic treatment with hexamethyldisilazane, and 0.6 parts of a silica fine particle having a volume average primary particle diameter of 0.012 μm and being subjected to a hydrophobic treatment with a silicone oil were added. The particles were mixed at 3,500 rpm for 15 minutes and sieved through a 200 mesh sieve to obtain a toner.

Dv50 of the toner particle was 5.95 μm, and the average circularity was 0.959.

### Example 2

A toner was produced by the same method as in Example 1 except that the components in Recipe 2 below were used and the holding temperature (ripening temperature) in the round shape forming step was set to 80.0° C.

Dv50 of the toner particle was 6.32 μm, and the average circularity was 0.960.

### <Recipe 2>

<Particle Growth Process>

| | |
|---|---|
| Primary Polymer Particle Dispersion Liquid | 80 parts as solid content |
| B1 (for core) | |
| Primary Polymer Particle Dispersion Liquid | 20 parts as solid content |
| C2 (for shell) | |
| Colorant (Pigment Blue 15:3) dispersion | 4.4 parts as colorant solid |
| liquid | content |
| Aqueous 20% DBS solution | 0.1 parts as solid content |
| Aqueous 5% ferrous sulfate solution | 0.52 parts as solid content |
| Aqueous 0.5 mass % aluminum sulfate | 0.2 parts as solid content |
| solution | |

<Round Shape Forming Step>

| | |
|---|---|
| Aqueous 20% DBS solution | 4.0 parts as solid content |

### Example 3

A toner was produced by the same method as in Example 1 except that the components in Recipe 2 were used and the holding temperature (ripening temperature) in the round shape forming step was set to 85.7° C.

Dv50 of the toner particle was 6.42 μm, and the average circularity was 0.961.

### Example 4

A toner was produced by the same method as in Example 1 except that the components in Recipe 2 were used and the holding temperature (ripening temperature) in the round shape forming step was set to 80.0° C.

Dv50 of the toner particle was 6.09 μm, and the average circularity was 0.958.

### Example 5

A toner was produced by the same method as in Example 1 except that the components in Recipe 2 were used and the holding temperature in the round shape forming step was set to 78.5° C.

Dv50 of the toner particle was 6.28 μm, and the average circularity was 0.956.

### Comparative Example 1

A toner was produced by the same method as in Example 1 except that the components in Recipe 3 below were used and the holding temperature (ripening temperature) in the round shape forming step was set to 93.5° C.

Dv50 of the toner particle was 6.27 μm, and the average circularity was 0.959.

### <Recipe 3>

<Particle Growth Process>

| | |
|---|---|
| Primary Polymer Particle Dispersion Liquid | 90 parts as solid content |
| B2 (for core) | |
| Primary Polymer Particle Dispersion Liquid | 10 parts as solid content |
| B2 (for shell) | |
| Colorant (Pigment Blue 15:3) dispersion | 4.4 parts as colorant solid |
| liquid | content |
| Aqueous 20% DBS solution | 0.07 parts as solid content |
| Aqueous 5% ferrous sulfate solution | 0.52 parts as solid content |
| Aqueous 0.5 mass % aluminum sulfate | 0.05 parts as solid content |
| solution | |

<Round Shape Forming Step>

| | |
|---|---|
| Aqueous 20% DBS solution | 4.0 parts as solid content |

### Comparative Example 2

A toner was produced by the same method as in Example 1 except that the components in Recipe 4 below were used and the holding temperature (ripening temperature) in the round shape forming step was set to 74.7° C.

Dv50 of the toner particle was 6.21 μm, and the average circularity was 0.961.

### <Recipe 4>

<Particle Growth Process>

| | |
|---|---|
| Primary Polymer Particle Dispersion Liquid | 80 parts as solid content |
| B1 (for core) | |
| Primary Polymer Particle Dispersion Liquid | 20 parts as solid content |
| C3 (for shell) | |
| Colorant (Pigment Blue 15:3) dispersion | 4.4 parts as colorant solid |
| liquid | content |
| Aqueous 20% DBS solution | 0.07 parts as solid content |
| Aqueous 5% ferrous sulfate solution | 0.52 parts as solid content |
| Aqueous 0.5 mass % aluminum sulfate | 0.05 parts as solid content |
| solution | |

<Round Shape Forming Step>

| | |
|---|---|
| Aqueous 20% DBS solution | 4.0 parts as solid content |

### Comparative Example 3

A toner was produced by the same method as in Example 1 except that the components in Recipe 5 below were used and the holding temperature (ripening temperature) in the round shape forming step was set to 86.2° C.

Dv50 of the toner particle was 6.61 μm, and the average circularity was 0.961.

### <Recipe 5>

<Particle Growth Process>

| | |
|---|---|
| Primary Polymer Particle Dispersion Liquid | 80 parts as solid content |
| B2 (for core) | |
| Primary Polymer Particle Dispersion Liquid | 20 parts as solid content |
| C4 (for shell) | |
| Colorant (Pigment Blue 15:3) dispersion | 4.4 parts as colorant solid |
| liquid | content |
| Aqueous 20% DBS solution | 0.07 parts as solid content |
| Aqueous 5% ferrous sulfate solution | 0.52 parts as solid content |
| Aqueous 0.5 mass % aluminum sulfate | 0.05 parts as solid content |
| solution | |

<Round Shape Forming Step>

| | |
|---|---|
| Aqueous 20% DBS solution | 4.0 parts as solid content |

### <Measurement Results>

The measurement results are shown together in Table 1.

TABLE 1

| | | Example, Comparative Example | | | | | | | |
|---|---|---|---|---|---|---|---|---|---|
| | | | | | | | Comparative | Comparative | Comparative |
| | | Example 1 | Example 2 | Example 3 | Example 4 | Example 5 | Example 1 | Example 2 | Example 3 |
| Core | Tg of core particle (° C.) | 50 | 50 | 50 | 50 | 50 | 62.5 | 50 | 50 |
| Shell | Amount of release agent in resin | 29.8 | 42.1 | 42.1 | 42.1 | 42.1 | 9.3 | 28.7 | 42.1 |
| | fine particle relative to the entire | | | | | | | | |
| | resin fine particle (%) | | | | | | | | |
| | Tg of resin fine particle (=Tg of | 86.1 | 86.1 | 86.1 | 86.1 | 86.1 | 62.5 | 62.5 | 75.0 |
| | shell) (° C.) | | | | | | | | |
| | Blending amount of resin fine particle | 20 | 20 | 20 | 20 | 20 | 10 | 20 | 20 |
| | relative the entire toner base particle | | | | | | | | |
| | (core particle + resin fine particle) | | | | | | | | |
| | (%) | | | | | | | | |
| Mass ratio of release agent in toner particle (%) | | 5.86 | 8.42 | 8.42 | 8.42 | 8.42 | 9.00 | 4.74 | 8.42 |
| Amount of release agent contained outside of | | 100 | 100 | 100 | 100 | 100 | 13 | 26 | 75 |
| approximate oval sphere relative to amount of | | | | | | | | | |
| all release agent in toner base particle (%) | | | | | | | | | |
| Tg of resin fine particle (Tg of shell) − Tg of | | 36.1 | 36.1 | 36.1 | 36.1 | 36.1 | 0.0 | 12.5 | 25.0 |
| core particle (° C.) | | | | | | | | | |
| Ripening temperature (° C.) | | 74.8 | 80.0 | 85.7 | 80.0 | 78.5 | 93.5 | 74.7 | 86.2 |
| Volume median diameter (Dv) | | 5.95 | 6.32 | 6.42 | 6.09 | 6.28 | 6.27 | 6.21 | 6.61 |
| Average circularity | | 0.959 | 0.960 | 0.961 | 0.958 | 0.956 | 0.959 | 0.961 | 0.961 |
| Percent (%) of number of toner base particles | | 3.43 | 1.14 | 0.49 | 2.42 | 0.74 | 0.76 | 0.74 | 1.36 |
| of 0.8 to 3.0 μm | | | | | | | | | |
| Percent (%) of release agent in toner base | | 6.15 | 7.90 | 10.3 | 8.32 | 9.23 | 10.00 | 5.97 | 10.8 |
| particle detected by DSC | | | | | | | | | |
| Calculated value of BET specific surface area | | 0.942 | 0.887 | 0.873 | 0.921 | 0.893 | 0.894 | 0.903 | 0.848 |
| of true sphere with a diameter corresponding | | | | | | | | | |
| to volume average particle diameter (Dv) | | | | | | | | | |
| (m²/g) | | | | | | | | | |
| BET Specific surface area (m²/g) (measured | | 2.910 | 1.749 | 1.459 | 2.474 | 2.274 | 1.035 | 0.953 | 0.910 |
| value) | | | | | | | | | |
| [Measured value/calculated value] of BET | | 3.09 | 1.93 | 1.67 | 2.69 | 2.55 | 1.16 | 1.06 | 1.07 |
| specific surface area | | | | | | | | | |
| Shape factor | | 247 | 238 | 217 | 247 | 234 | 100 | 106 | 137 |
| Blocking resistance (50° C., 40%, 24 hours) | | A | A | AA | AA | AA | A | C | B |
| Fixing | Low-temperature fixability (130° C.) | A | AA | AA | AA | AA | C | AA | C |
| test | High-temperature fixability (210° C.) | A | AA | AA | AA | AA | AA | C | C |

The toner using the toner base particle of the present invention was excellent in both the blocking resistance and the fixing test (low-temperature fixability, high-temperature fixability and fixing temperature width) (Examples 1 to 5).

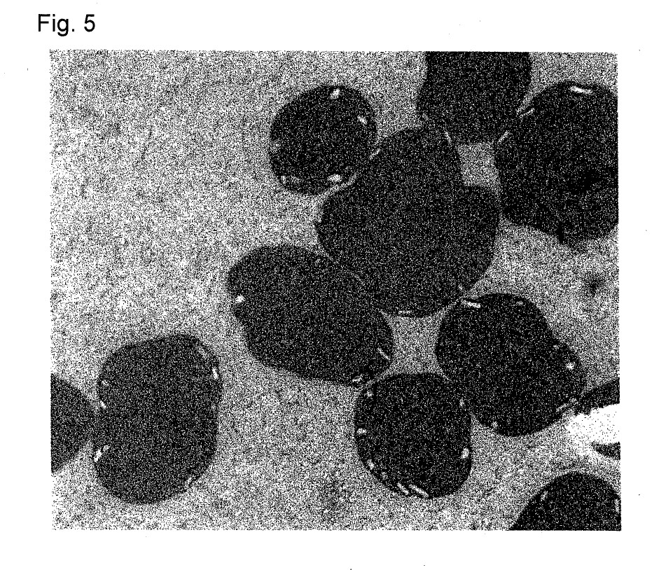

FIG. 5 shows a cross-sectional TEM photograph of the toner base particle of Example 1. As seen from FIG. 5, in the toner base particle of the present invention, the release agent is localized on the toner base particle surface.

On the other hand, in Comparative Example 1, the release agent was contained in a ratio of 10% in each of the shell and the core, and the release agent was uniformly dispersed in the toner base particle. In addition, since the shell-forming resin fine particle was not localized on the surface, the shape factor was decreased.

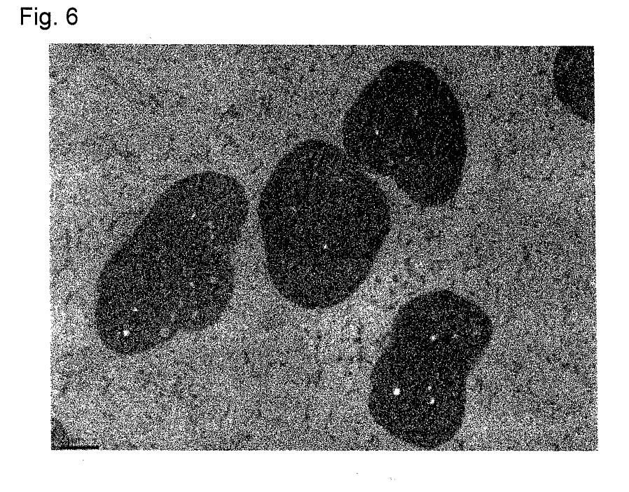

FIG. 6 shows a cross-sectional TEM photograph of the toner base particle of Comparative Example 1. As seen from FIG. 6, in the toner base particle of Comparative Example 1, the release agent is present in the core portion and is not localized on the toner base particle surface.

In Comparative Example 2, the release agent was contained only in the shell and since Tg of the shell is 62.5° C. and is lower than the ripening temperature of 74.7° C. for the round shape formation, the resin portion of the shell was deformed, and the release agent moved outside the shell and partially slipped inside of the core, leading to no surface localization of the release agent or the resin fine particle that should form the shell, as a result, the shape factor was decreased.

In Comparative Example 3, the release agent was contained only in the shell and since Tg of the shell is 75° C. and is lower than the ripening temperature of 86.2° C. for the round shape formation, the shell was partially compatibilized with the resin of the core, leading to a rise in Tg of the core, as a result, the low-temperature fixing became defective. Similarly to Comparative Example 2, the release agent or the resin fine particle that should form the shell was not localized on the toner base particle surface, the high-temperature fixing and blocking resistance were deteriorated. In addition, because of no surface localization of the shell, the shape factor was decreased.

In Examples 1 to 5, assuming that the volume median diameter Dv50 of the toner base particle is R [μm], all release agents were present in the outer shell between the surface of the toner base particle and the “R/4 [μm] from the surface of the toner base particle”, but in Comparative Examples 1 to 3, the release agent was not entirely present in the outer shell between the surface of the toner base particle and the “R/4 [μm] from the surface of the toner base particle”.

In addition, the cross-sectional view of the toner base particle obtained by TEM observation was image-processed to measure the circumferential length of the cross-section of the particle. In all of Examples 1 to 5, the ratio of the release agent in the circumferential length of the cross-section was 1.0% or less.

These results reveal that the toner using the toner base particle of the present invention was excellent in both the blocking resistance and the fixing test (low-temperature fixability, high-temperature fixability and fixing temperature width) (Examples 1 to 4), but the toner using the toner base particle of Comparative Examples 1 to 3 was poor in the blocking resistance and/or the fixing test.

While the invention has been described in detail and with reference to specific embodiments thereof, it will be apparent to one skilled in the art that various changes and modifications can be made therein without departing from the spirit and scope of the invention. This application is based on Japanese Patent Application (Patent Application No. 2013-057197) filed on Mar. 19, 2013, Japanese Patent Application (Patent Application No. 2013-071877) filed on Mar. 29, 2013, and Japanese Patent Application (Patent Application No. 2014-019514) filed on Feb. 4, 2014, the entirety of which is incorporated herein by way of reference.

### INDUSTRIAL APPLICABILITY

The electrostatic image developing toner (obtained by external addition to the toner base particle) of the present invention is excellent in the low-temperature fixability, development properties and storage stability and can achieve balancing these performances and since the toner base particle as a whole effectively exhibits the release effect with a small release agent content, making low-temperature fixing possible and in turn, reducing the problem of dust generation, the toner can be widely used in the field of image formation utilizing electrostatic photography, such as electrophotographic copying machine, printer and printing press.

### DESCRIPTION OF REFERENCE NUMERALS AND SIGNS

11: Cross-section of toner base particle
12: Approximate ellipse
a: Short diameter
b: Long diameter

1. A toner base particle having a core-shell structure, which comprise: a core particle containing at least a binder resin and a colorant; and as a shell, a resin fine particle containing at least a release agent and attaching to the surface of the core particle, wherein
when out of TEM images of a cross-section of said toner base particle, a cross-sectional image where a long diameter of the cross-section is 80% or more of a volume median diameter (Dv) of said toner base particle is image-processed and an approximate ellipse having an area corresponding to 84.6% of a cross-sectional area of said toner base particle is delineated inside of said cross-section, a mass of the release agent contained outside of an approximate oval sphere obtained by rotating said approximate ellipse around the major axis thereof is from 50 to 100% of a mass of all release agents in said toner base particle, and a shape factor of said toner base particle is 150 or more.

2. A toner base particle having a core-shell structure, which comprise: a core particle containing at least a binder resin and a colorant; and as a shell, a resin fine particle containing at least a release agent and attaching to the surface of the core particle, wherein
a mass of the release agent in said shell is from 50 to 100% of a mass of all release agent in said toner base particle and a shape factor of said toner base particle is 150 or more.

3. The toner base particle as claimed in claim 1, wherein a particle size distribution (Dv/Dn) obtained by dividing the volume median diameter (Dv) by a number median diameter (Dn) of said toner base particle is from 1.05 to 1.17, and a BET specific surface area of said toner base particle is from 1.3 to 6 times a calculated value of a BET specific surface area of a true sphere having a diameter corresponding to the volume median diameter (Dv) of said toner base particle.

4. The toner base particle as claimed in claim 1, wherein an average circularity of the toner base particle as measured by a flow-type particle image analyzer is 0.955 or more, and the number of toner base particles of 0.8 to 3.0 μm as measured by a flow-type particle image analyzer is 5% or less of the number of all toner base particles.

5. A method for producing the toner base particle claimed in claim 1, which is a method for producing a toner base particle having a core-shell structure and a shape factor of 150 or more, which comprise: a core particle containing at least a binder resin and a colorant; and as a shell, a resin fine particle containing at least a release agent and attaching to the surface of the core particle, the method comprising incorporating said release agent into said resin fine particle in an amount of 20 to 50 mass % relative to the entirety of said resin fine particle.

6. The method for producing a toner base particle as claimed in claim 5, wherein said core particle does not contain a release agent.

7. The method for producing a toner base particle as claimed in claim 5, wherein said resin fine particle is attached to the surface of said core particle in an amount of 5 to 25 mass % relative to the total mass of said core particle and said resin fine particle.

8. The method for producing a toner base particle as claimed in claim 5, wherein a temperature at the time of adding said resin fine particle to form a shell on the surface of said core particle is set to a temperature range from the glass transition temperature (Tg) of said core particle to the glass transition temperature (Tg) of said resin fine particle forming the shell.

9. The method for producing a toner base particle as claimed in claim 5, wherein the glass transition temperature (Tg) of said resin fine particle forming the shell is higher by 25° C. or more than the glass transition temperature (Tg) of said core particle.

10. A toner base particle produced by the method of producing a toner base particle claimed in claim 5.

11. An electrostatic image developing toner obtained by externally adding an external additive to a toner base particle, wherein a toner base particle after dispersing said electrostatic image developing toner in water and removing the external additive by using an external additive removing method of applying an ultrasonic wave in the presence of a nonionic surfactant, is the toner base particle claimed in claim 1.

12. An electrostatic image developing toner obtained by externally adding an external additive to a toner base particle, wherein a toner base particle after dispersing said electrostatic image developing toner in water and removing the external additive by using an external additive removing method of applying an ultrasonic wave in the presence of a nonionic surfactant, is the toner base particle claimed in claim 10.

13. An electrostatic image developing toner obtained by externally adding an external additive to the toner base particle claimed in claim 1.

14. An electrostatic image developing toner obtained by externally adding an external additive to the toner base particle claimed in claim 10.

15. A toner cartridge comprising the electrostatic image developing toner claimed in claim 11.

16. A toner cartridge comprising the electrostatic image developing toner claimed in claim 12.

17. A toner cartridge comprising the electrostatic image developing toner claimed in claim 13.

18. A toner cartridge comprising the electrostatic image developing toner claimed in claim 14.

19. The toner base particle as claimed in claim 2, wherein a particle size distribution (Dv/Dn) obtained by dividing the volume median diameter (Dv) by a number median diameter (Dn) of said toner base particle is from 1.05 to 1.17, and a BET specific surface area of said toner base particle is from 1.3 to 6 times a calculated value of a BET specific surface area of a true sphere having a diameter corresponding to the volume median diameter (Dv) of said toner base particle.

20. The toner base particle as claimed in claim 2, wherein an average circularity of the toner base particle as measured by a flow-type particle image analyzer is 0.955 or more, and the number of toner base particles of 0.8 to 3.0 μm as measured by a flow-type particle image analyzer is 5% or less of the number of all toner base particles.

21. A method for producing the toner base particle claimed in claim 2, which is a method for producing a toner base particle having a core-shell structure and a shape factor of 150 or more, which comprise: a core particle containing at least a binder resin and a colorant; and as a shell, a resin fine particle containing at least a release agent and attaching to the surface of the core particle, the method comprising incorporating said release agent into said resin fine particle in an amount of 20 to 50 mass % relative to the entirety of said resin fine particle.

22. An electrostatic image developing toner obtained by externally adding an external additive to a toner base particle, wherein a toner base particle after dispersing said electrostatic image developing toner in water and removing the external additive by using an external additive removing method of applying an ultrasonic wave in the presence of a nonionic surfactant, is the toner base particle claimed in claim 2.

23. An electrostatic image developing toner obtained by externally adding an external additive to the toner base particle claimed in claim 2.
